(19) United States
(12) Patent Application Publication
(10) Pub. No.: US 2026/0021537 A1
(43) Pub. Date: Jan. 22, 2026

(54) Devices for Attachment to Rotary Tools

(71) Applicant: John Cerwin, Gurnee, IL (US)

(72) Inventor: John Cerwin, Gurnee, IL (US)

(21) Appl. No.: 19/290,256

(22) Filed: Aug. 4, 2025

Related U.S. Application Data
(63) Continuation-in-part of application No. 17/013,173, filed on Sep. 4, 2020.
(60) Provisional application No. 62/895,703, filed on Sep. 4, 2019.

(51) Int. Cl. B23B 47/28; B23B 45/00

(52) U.S. Cl. CPC B23B 47/28; B23B 45/003

(57) ABSTRACT

A two part drilling alignment system that includes worksurface alignment component and a reflector part, where the worksurface alignment component includes a body having a front surface that has a planar region and a light source that that projects a light beam transverse to the planar region, and the reflector part is a flat specular reflective surface that is attached to a rotary tool and oriented perpendicular to an axis of rotation of the rotary tool.

### CROSS REFERENCE TO RELATED APPLICATIONS

This a continuation-in-part of U.S. application Ser. No. 17/013,173. The Applicant claims the benefit of the filing date of U.S. Application No. 62/895,703 and pending U.S. application Ser. No. 17/013,173.

### BACKGROUND OF THE INVENTION

Do it yourself (“DIY”) workers as well as skilled craftsmen and women often experience the need to learn, enhance, improve, and augment their capabilities and craftmanship. Users of rotary equipment may seek out the techniques necessary to perform a specific task or may need guidance to assist with proper use of the tool, such as a drill, for the first time. Skilled craftsmen may want to become better at their trade and may require enhanced precision or may need to simplify a task that requires precision over several repetitive operations.

For example, it is difficult to maintain correct alignment of a rotary boring tool with a work surface such as a workpiece being drilled by a hand-held power drill. This is especially true when drilling longer distances as a minor misalignment of a rotary boring tool with regards to a work surface can ultimately result in a non-perpendicular or severely angled bore hole. Further, it is difficult to know the depth of a drill bit as it bores into a worksurface. This is especially true for longer drilling setups, or for tasks that require a specific drill bit depth in repetitive drilling operations.

Many standard rotary tools are limited to their primary function and do not provide a manner to adding features and functionality that can be used to enhance, improve, or augment the tool. Many of the secondary features offered by standard rotary tools such as worksurface illumination or a bubble level alignment on a power drill are often ineffective or insufficient. Bubble levels only work in a gravity-restricted plane, and built-in power drill illumination is typically off-center and too dim.

There is a continuing need for a simple means of extending or adding features and functionality that enhance, improve, or augment the capabilities of rotary tools and thus the capabilities and skills of rotary tool users. Moreover, there is also need for new features and functionality to be offered in a universal form that works and integrates easily with a wide variety of rotary tool brands and models.

### BRIEF DESCRIPTION OF THE INVENTION

The present invention is directed at devices designed to be magnetically attached to a chuck or a spinning element of a rotary tool and which supports additional tools. The present invention is directed at rotary tool apparatus attachment systems that can be used for alignment systems, depth penetration measurement systems, guidance and control systems, calibration systems, illumination, as well as debris removal, cleaning, sanding, cutting, grinding, or polishing. In connection with some embodiments, the device or system can be used to attach an element to a rotating element in applications that do not require high torque. In other applications, powerful neodymium magnets are used that firmly hold in place even when significant torque is applied to the device. Embodiments of the invention can be used with different rotary tools including drills, rotary cutting devices such as a circular saw, a miter saw, a grinder, or stationary rotary tools such as a drill press, mill or lathe. Embodiments can include further elements that enhance, improve, augment, or facilitate the use of the rotary tool, including but not limited to a worksurface alignment system, a drilling depth system, a worksurface light, a fan to clear debris from a worksurface or a worksurface guidance and control system. Embodiments of the device can also be used to hold cutting, cleaning, sanding, cutting, grinding, or polishing elements and a user can quickly and easily change out different grades of the respective elements. Embodiments can also be used for calibration operations such as mill tramming, which ensures that the mill head is perpendicular to the mill table's X and Y axis.

This invention is directed to a rotary tool apparatus attachment and alignment systems and, in particular, provides a reflecting device on a rotary tool and complementary laser device that may be posited on a work surface and which projects a laser beam which can be reflected by said reflecting device.

Embodiments of the invention includes a device having one or more magnets that are configured to magnetically attach to a surface of the rotating portion of a rotary tool so that when the rotating portion of the rotary tool rotates, the apparatus also rotates. In an embodiment, the apparatus includes spacer elements for aligning the apparatus with the rotating portion of a rotary tool so that both are aligned during rotation.

In an embodiment, the rotary tool is a rotary boring device like a drill. In other embodiments, the device is used with a rotary cutting device such as a miter saw or grinder. As disclosed herein, devices according to embodiments of the invention include one or more magnets that are configured to magnetically attach to a rotating element of a rotary tool so that when the rotating portion of the rotary tool rotates, the device that supports other tools will also rotate. Embodiments of the invention optionally include an alignment spacer ring apparatus that centers the device on the rotational axis of the rotary tool by engagement with a chuck. Implementation of these embodiments can be used for a variety of purposes such as laser or focused light beam that, when attached to the rotating portion of a rotary tool, assist the user with aligning the cutting element or drill bit during use or for depth measurement

An advantage of the invention is that a single magnet or set of magnets, affixed to the apparatus, can be used to attach the apparatus to a wide variety of rotary tools such as power drills of different brands and models. Further, a single magnet or set of magnets creates a non-permanent connection between the rotary portion of a rotary tool and the apparatus, so the apparatus can be quickly attached or removed from the rotary tool as needed without the need for a mechanical attachment and/or release mechanism. The magnetic connection also serves as a safety mechanism as the apparatus will disconnect from the rotating portion of a rotary tool if the apparatus is obstructed during rotation by an external object.

Another advantage of an embodiment provides for the alignment of the rotating portion of the rotary tool and the apparatus. Apparatus alignment allows the entire system to operate more efficiently along a single common rotational axis which may provide stability, balance, efficiency, and precision during operation.

The present invention and associated embodiments further disclose improvements to U.S. Pat. Nos. 7,992,311, 10,150,167, 10,739,127, and U.S. patent application Ser. No. 16/418,256 which are incorporated by reference herein.

### BRIEF DESCRIPTION OF THE DRAWINGS

FIG. 1 is an isometric view of a first embodiment that is used to attach an apparatus to a rotating element of a rotary tool.

FIG. 2 is an exploded isometric view of embodiment from FIG. 1 of apparatus showing magnet 1 exposed along with cap 7 that covers it within the apparatus.

FIG. 3 is an exploded isometric view of the reverse side of the embodiment of FIG. 1 depicting the magnet exposed along with cap 7.

FIG. 4 depicts a sectional view of the embodiment of FIG. 1, including the apparatus and rotating portion of the rotary tool.

FIG. 5 depicts a partial sectional view of the embodiment of FIG. 1 along the plane that encloses a worksurface alignment system and the rotating portion of the rotary tool.

FIG. 6 is an exploded isometric view of a second embodiment depicting apparatus 42 and metallic ring 41 as well as magnet 55 affixed to rotating portion 46 of a rotary tool.

FIG. 7 is a reverse exploded isometric view of the embodiment of FIG. 6 depicting apparatus 42, metallic ring 41 and rotating portion 46 of a rotary tool.

FIG. 8 depicts a sectional view of the embodiment of FIG. 6 of apparatus 42, metallic ring 41, and magnet 55 affixed to rotating portion 46 of a rotary tool.

FIG. 9 is an isometric view of a rotary tool apparatus attachment and alignment system further embodiment that is used to attach apparatus 62 to rotating portion 66 of the rotary tool where apparatus 62 aligns with cutting tool 64.

FIG. 10 is a partially exploded isometric view of the embodiment of FIG. 9 wherein slot or opening 72 for cutting tool 64 is visible.

FIG. 11 is an isometric view of a rotary tool apparatus attachment and alignment system embodiment that is used to attach apparatus 82 to rotating portion 86 of the rotary tool where apparatus 82 aligns with cutting tool 84 using removable entity 91.

FIG. 12 is the same embodiment as FIG. 11 but depicts an isometric view with removeable entity 91 with slot 92 specifically for cutting tool 86.

FIG. 13 is an exploded isometric view of the embodiment from FIG. 11 that is used to attach apparatus 82 to rotating portion 86 of the rotary tool.

FIG. 14 is an exploded isometric view of the reverse side of the embodiment from FIG. 11 of apparatus 82 with magnet 81 exposed along with cap 87 or portion of the apparatus housing that covers or encloses it within apparatus 82.

FIG. 15 depicts a sectional view of the embodiment from FIG. 11 of apparatus 82 and rotating portion 86 of the rotary tool.

FIG. 16 depicts a partial sectional view of the embodiment from FIG. 11 along the plane that encloses worksurface alignment system 89 of apparatus 82 and rotating portion 86 of the rotary tool.

FIG. 17 depicts a side view of the rotary tool apparatus attachment and alignment system embodiment from FIG. 11 along with laser projections 106, 107, and 108 against worksurface 105.

FIG. 18 is an isometric view of a rotary tool apparatus attachment and alignment system embodiment that is used to attach apparatus 112 to rotating portion 116 of the rotary tool.

FIG. 19 is an exploded isometric view of the embodiment from FIG. 18 that is used to attach apparatus 112 to rotating portion 116 of the rotary tool along with cap 127 which has threaded element 121 and screws onto threaded element 125 on apparatus 112.

FIG. 20 is a reverse exploded isometric view of the embodiment from FIG. 18 along with cap 127 that contains contour element 120 that mirrors some portion 129 of rotating portion 116 of the rotary tool with the intent of centering apparatus 112 on the rotational axis of rotating portion 116 of the rotary tool.

FIG. 21 depicts a sectional view of the embodiment of FIG. 18 of apparatus 112 and rotating portion 116 of the rotary tool.

FIG. 22 is an isometric view of a rotary tool apparatus worksurface illumination system embodiment that is used to attach apparatus 132, which contains illumination elements to a rotating portion of the rotary tool.

FIG. 23 is an exploded isometric view of the embodiment of FIG. 22 that is used to attach apparatus 132 to rotating portion 136 of the rotary tool.

FIG. 24 is an exploded isometric view of the reverse side of the embodiment from FIG. 22 of apparatus 132 with magnet 131 exposed along with cap 133 that covers or encloses it within apparatus 132.

FIG. 25 depicts a sectional view of the embodiment of FIG. 22 of apparatus 132 and rotating portion 136 of the rotary tool and two illumination elements 140 and 142.

FIG. 26 is an isometric view of a rotary tool apparatus alignment system embodiment that is used to attach apparatus 152 to rotating portion 156 of the rotary tool.

FIG. 27 is an exploded isometric view of the embodiment of FIG. 26 that is used to attach apparatus 152 to rotating portion 156 of the rotary tool.

FIG. 28 depicts a sectional view of the embodiment of FIG. 26 of apparatus 152 and rotating portion 156 of the rotary tool and laser alignment element 163.

FIG. 29 is an isometric view of a rotary tool apparatus that can receive elements such as a sanding, abrasive, cleaning, grinding, or material application or removal pads.

FIG. 30 is a rear view in elevation of the embodiment of FIG. 29.

FIG. 31 is an exploded isometric view of the embodiment of FIG. 29.

FIG. 32 is a sectional view of a rotary tool apparatus of the embodiment of FIG. 29

FIG. 33 is an isometric view of a rotary tool apparatus attachment and alignment system embodiment that is used to attach apparatus 260 to the rotating portion of the rotary tool, namely, saw blade 262.

FIG. 34 the reverse side of saw blade 262 of FIG. 33.

FIG. 35 represents a closer view of the apparatus 260 of FIG. 33 and hex bolt 263 that secures saw blade 262 to the saw.

FIG. 36 is an isometric view of a rotary tool apparatus attachment and alignment system embodiment that is used to attach apparatus 270 to rotating portion of the rotary tool which in this case is saw blade 273.

FIG. 37 represents An enlarged view of the embodiment of FIG. 36.

FIG. 38 depicts an isometric view of a rotary tool apparatus attachment and alignment system embodiment with annular 310 ring where apparatus 300 attaches to rotating portion 306 of the rotary tool.

FIG. 39 depicts the embodiment of FIG. 38, but depicts an exploded isometric view of reverse depicting magnet 301 exposed along with cap 307.

FIG. 40 depicts a sectional view of apparatus 330 and rotating portion 326 of the rotary tool.

FIG. 41 depicts an isometric view of a rotary tool apparatus attachment and alignment system embodiment with annular 330 ring where apparatus 320 attaches to rotating portion 328 of the rotary tool.

FIG. 42 is the same embodiment as FIG. 41, but depicts an exploded isometric view of the reverse side of the device.

FIG. 43 is a perspective view of the rotary tool with a first embodiment of a reflector device.

FIG. 44 is a top perspective view of the tool holder element depicted in FIG. 43.

FIG. 45 is a sectional view of the embodiment of FIG. 44.

FIG. 46 is a perspective front view of a circular disk that is provided with a circular magnet around a central opening and which has a reflective front surface.

FIG. 47 is a perspective rear view of the circular disk of FIG. 44.

FIG. 48 is a sectional view of the disk of FIG. 44 along line A-A1.

FIG. 49 a sectional view of disk of FIG. 44 along line B-B1.

FIG. 50 is a perspective view of a rotary tool on which is attached the disk reflector device of FIG. 44.

FIG. 51 is a side view of a second embodiment of a worksurface alignment device that has legs that extend from its lower surface.

FIG. 52 is a perspective view of the embodiment of the worksurface alignment device depicted in FIG. 51.

FIG. 53 is a top view of a further embodiment of a worksurface alignment device that is placed on a user's finger.

FIG. 54 is top view of yet a further embodiment of a worksurface alignment device that is integrated on the finger of a glove.

FIG. 55 is a perspective view of a rotary tool with the disk reflector embodiment as depicted in FIGS. 46-50 in combination with a worksurface alignment device that is positioned on a work surface wherein the drilling bit is not perpendicular to the worksurface.

FIG. 56 is a perspective view of a rotary tool with the disk reflector embodiment as depicted in FIGS. 46-50 in combination with a worksurface alignment device that is positioned on a work surface wherein the drilling bit is perpendicular to the worksurface.

FIG. 57 is a perspective view of a further embodiment of a worksurface alignment device that includes a vacuum device for removing debris created by a drilling operation shown in cooperation with a reflector device that is mounted on a drill.

FIG. 58 is a rear plan view of the worksurface alignment device shown in FIG. 57, reflector device on drill.

FIG. 59 is a perspective view of a further embodiment a worksurface alignment component.

FIG. 60 is a perspective view of a reflector device that is designed to be attached to the body of a rotary tool.

FIG. 61 is a perspective view of another embodiment of a reflector device attached to a rotary tool.

FIG. 62 is a perspective view of a reflector device that may be attached to a rotary tool using a threaded rod.

FIG. 63 is a top plan view of a further embodiment of a worksurface alignment component that may be used with a reflector device.

FIG. 64 is a bottom plan view of the embodiment of the work surface alignment component depicted in FIG. 63.

FIG. 65 is a perspective view of the embodiment of the worksurface embodiment of FIG. 63.

FIG. 66 is a perspective view of a drill with a reflector device and a worksurface alignment component that also includes a stud detector feature.

### DETAILED DESCRIPTION OF EMBODIMENTS

The present invention is generally directed to rotary tool apparatus attachment and alignment systems and devices. The rotary tool that can be used with the invention can be anything known in the art, such as a rotary boring device like a drill or a rotary cutting device such as a circular saw, whereas the apparatus can be anything that enhances, improves, augments, or facilitates the rotary tool, including but not limited to a worksurface alignment system, a drilling depth system, a worksurface light, a worksurface guidance system, debris removal system, or a cutting sanding, cleaning, polishing, or material application or removal system.

For purposes of simplicity, the embodiments described in this specification are provided in the context of power drills and circular saws, but can also be applied towards other types of rotary tools known in the art, including but not limited to construction tools, manufacturing tools (such as a mill, a lathe, or a drill press), maintenance tools, lawn care tools, earth moving tools, or farming tools. Moreover, the rotary tool can simply be a rotary element of a larger system or mechanism such as a flywheel, crankshaft, gear, pully, or wheel.

### Magnetic Attachment Embodiments

A feature of embodiments of the system is that a single magnet or set of magnets can be used to attach an apparatus to a wide variety of rotary tools such as power drills of different brands and models.

Further, a single magnet or set of magnets create a non-permanent connection to the rotary portion of a rotary tool, so the associated apparatus can be quickly attached or removed from the rotary tool as needed without the need for a mechanical attachment and release mechanism.

The non-permanent magnetic connection also serves as a safety mechanism as the apparatus will disconnect from the rotating portion of a rotary tool if the apparatus is obstructed during rotation by an external object or if the load is increased and there is a danger of causing damage to the motor and or the worksurface.

The magnet or magnets used to attach the apparatus to the rotating portion of the rotary tool may be permanent magnets, electromagnets, or some combination thereof. Permanent magnets retain their magnetism, whereas electromagnets require a source of electricity and can be turned on or off. Permanent magnets are commonly available in a variety of types including but not limited to neodymium iron boron, samarium cobalt, alnico, ceramic ferrite, as well as other types known in the art.

The magnet configuration can be a single magnet whose characteristics such as shape, size, magnetized direction, grade, etc. are conducive to the purpose of an embodiment, or two or more magnets whose individual characteristics such as shape, size, magnetized direction, grade, etc. and group characteristics such as arrangement, orientation, etc., are conducive to the purpose of an embodiment.

Another characteristic of the magnet configuration is the placement or position of the magnet or magnets within the apparatus with regards to the corresponding metallic area or surface of the rotary tool. A magnet or set of magnets will produce its strongest magnetically attractive field when in direct contact with another metallic object (or another correctly oriented magnet or set of magnets). Therefore, the placement and position of the magnets in or on the apparatus, and thus the resulting magnetically attractive field, must also be conducive to the purpose of an embodiment. In several embodiments contained in this specification, there is minimal or no separation between the magnet (or set of magnets) in or on the apparatus and the metallic area or surface of the rotary tool. Minimal or no separation produces a strong magnetically attractive field. In several other embodiments, this arrangement is reversed with the magnet (or set of magnets) in the rotary tool and a metallic ring or surface in or on the apparatus. In this embodiment, there is also minimal or no separation between the magnet (or set of magnets) in the rotary tool and the metallic ring or surface in or on the apparatus. In yet another embodiment contained in this specification, both the rotational portion of the rotary tool and apparatus contain magnets that are oriented so as to be magnetically attracted to each other. In this embodiment, there is also minimal or no separation between the magnet (or set of magnets) in the rotational portion of the rotary tool and the magnet (or set of magnets) in or on the apparatus.

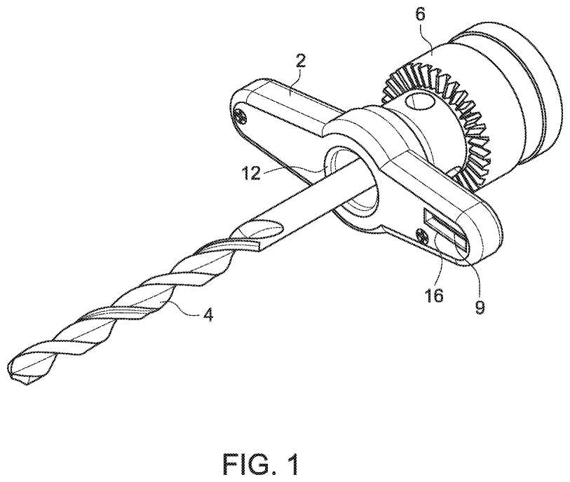

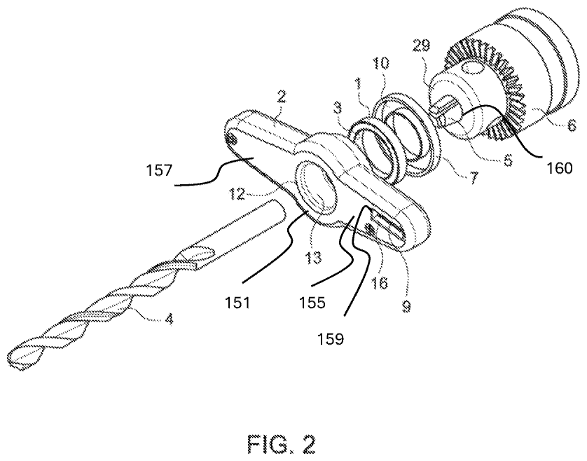

Now referring to FIG. 1, in a first embodiment of the invention a magnet, not shown, is a single, permanent, ring-shaped element that is affixed within apparatus 2, and cutting tool 4 comprises a drill bit. As seen in FIG. 2, magnet 1 is a ring-shaped element having inner diameter 3 that is large enough to insert and transit the largest possible cutting tool 4 that may fit within chuck jaws 5 of rotating element 6. Magnet 1 may be neodymium iron boron, samarium cobalt, alnico, ceramic ferrite, as well as other types known in the art. In this embodiment the shape of apparatus 2 allows it to be virtually transparent while rotating which permits the user to see the surface that is being engaged by cutting tool 4. Extending from opposite side of central core section 10 are arms 11a and 11b. Central core section surrounds cavity 13. Referring to FIG. 2, inner diameter 3 of ring magnet 1 (and opening of cap 7) is large enough to accommodate a variety of sized cutting tools that may be received in jaws 5 of chuck 6. Magnet 1 is used to attach apparatus 2 to a collar or surface 29 of rotating portion 6 of a rotary tool. In this embodiment, apparatus 2 contains a laser and optics in optics assembly that are used for worksurface alignment and which are seated in a cavity in the front surface of the device. The laser projection or projections emerge from one or more windows 16 in apparatus 2. In further embodiments, additional laser and optic combinations may be provided for depth detection, worksurface alignment or both.

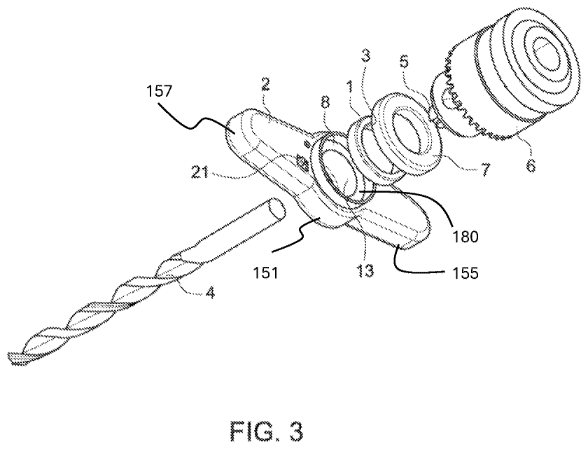

FIG. 3, which depicts an exploded view of the reverse side of apparatus 2 shows magnet 1 exposed, along with cap 7 which covers magnet 1 within apparatus 2. FIG. 3 also depicts annular ledge 8 within apparatus 2 that receives magnet 1, and power switch 21 that can turn the laser or lasers in apparatus 2 on or off.

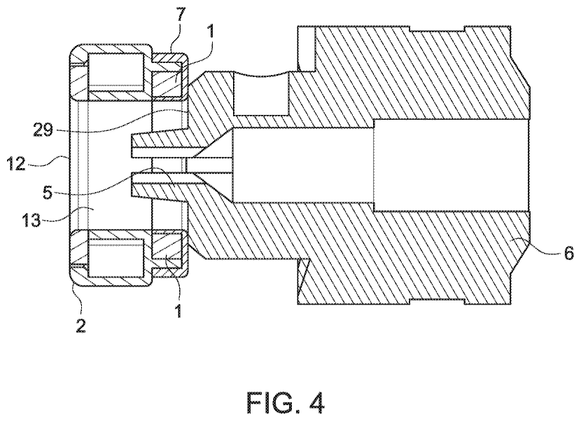

FIG. 4, a sectional view of the embodiment depicted in FIGS. 1, 2, and 3, shows the arrangement of apparatus 2 in engagement with rotational element 6 of a rotary tool. As shown here cap 7 is in contact with surface 29 of rotational element 6 of a rotary tool. Immediately behind cap 7 is magnet 1 which is connected by magnetic attraction to surface 29 of rotational element 6 of a rotary tool. Also depicted in FIG. 4 is cavity 13 in apparatus 2 that is large enough to accommodate both jaws 5 of chuck 6 and a variety of sized cutting tools that may be received in jaws 5 of chuck 6. Hole 12 in the front of the apparatus is also large enough to accommodate a variety of sized cutting tools that may be received in jaws 5 of chuck 6.

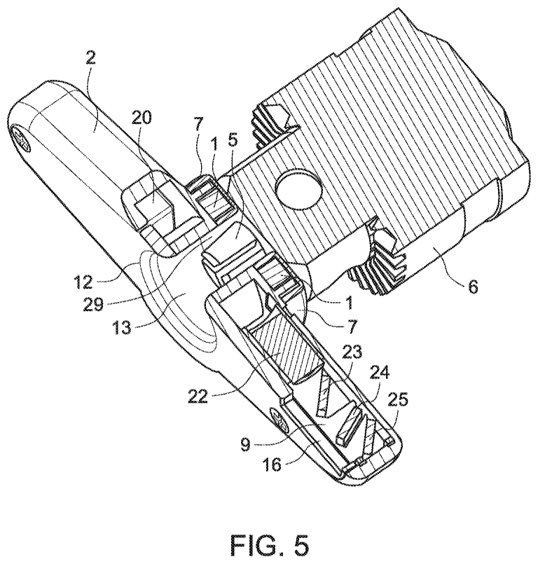

FIG. 5 depicts a partial sectional view of the embodiment from FIGS. 1, 2, 3, and 4 along the plane that encloses optics assembly 9 within apparatus 2 and rotating portion 6 of the rotary tool. In this embodiment optics assembly 9 contains laser 22, two beam splitters 23 and 24, and first side mirror 25 that projects beams (not pictured) through window 16, and operate in combination to provide worksurface alignment functionality. Battery 20 that powers the laser is also depicted. In further embodiments, additional laser and optic combinations may be provided for depth detection, or both depth detection and work surface alignment, as well as a separate light or set of lights that are used to illuminate the worksurface. Further embodiments utilize several magnets arranged in a pattern versus single ring magnet 1, or utilize one or more electro-magnets that are also powered by battery 20.

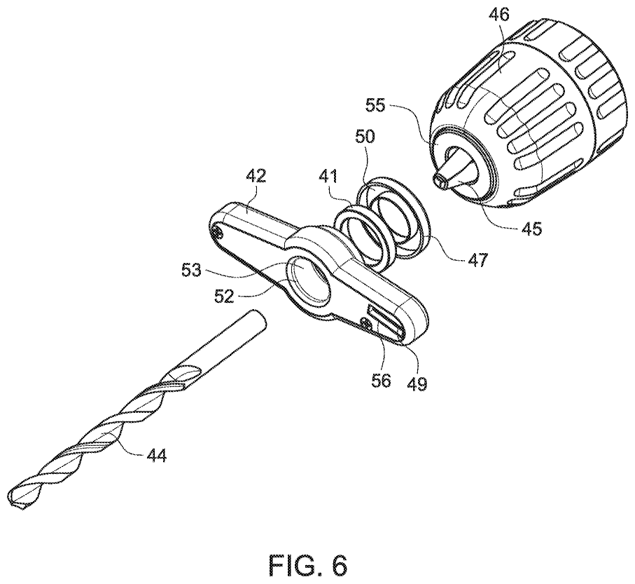

Alternatively, as shown in FIG. 6, a single, permanent, ring-shaped magnet 55 is attached to rotating portion 46 of a rotary tool. In this embodiment, apparatus 42 contains attached or embedded ferrous metallic ring 41 that has a similar diameter to ring-shaped magnet 55 that is affixed to rotating portion 46 of a rotary tool. In this embodiment, metallic ring 41 is a metal material that is attracted to magnets such as iron, steel, cobalt, nickel, or other magnetically attractive materials known in the art. In this embodiment, the inner diameter of both ring-shaped magnet 55 and metallic ring 41 are also large enough to allow for the insertion of cutting tool 44, such as a drill bit for the operation, and chuck jaws 45. Ferrous metallic ring 41 is therefore used to attach apparatus 42 to magnet 55 which is affixed to or built into rotating portion 46 of the rotary tool.

In this embodiment, apparatus 42 contains a laser and optics in optics assembly 49 that are used for worksurface alignment. The laser projection or projections emerge from one or more windows 56 in apparatus 42. In further embodiments, additional laser and optic combinations may be provided for depth detection, worksurface alignment or both.

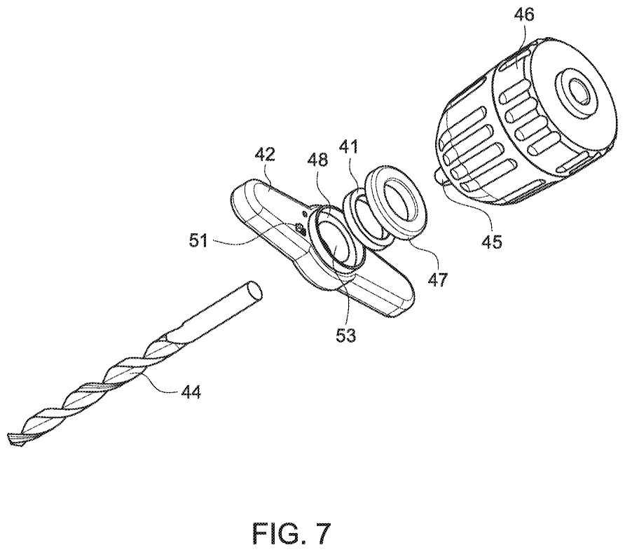

FIG. 7, which depicts an exploded view of the reverse side of FIG. 6. with ferrous metallic ring 41 exposed, along with cap 47 covers ferrous metallic ring 41 within apparatus 42. FIG. 7 also depicts annular cavity 48 within apparatus 42 that receives ferrous metallic ring 41, and power switch 51 that can turn the laser or lasers in apparatus 42 on or off.

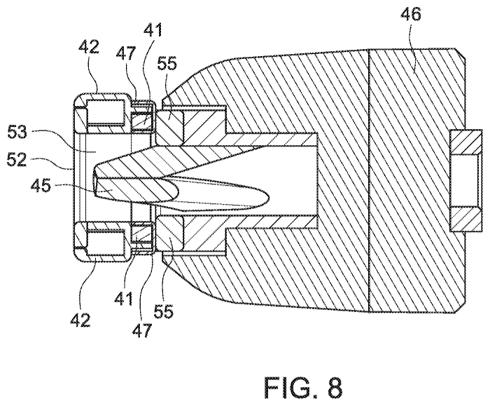

FIG. 8, a sectional view of the device of FIGS. 6 and 7, shows the arrangement of apparatus 42 in engagement with rotational element 46 of a rotary tool. As shown here cap 47 is in contact with magnet 55 which is affixed to or built into rotating portion 46 of a rotary tool. Immediately behind cap 47 is ferrous metallic ring 41 which is connected by magnetic attraction to magnet 55 which is affixed to or built into rotating portion 46 of a rotary tool. Also depicted in FIG. 8 is cavity 53 in apparatus 42 which is large enough to accommodate both jaws 45 of chuck 46 and a variety of sized cutting tools that may be received in jaws 45 of chuck 45. Hole 52 in the front of the apparatus is also large enough to accommodate a variety of sized cutting tools that may be received in jaws 45 of chuck 46.

In a contemplated further embodiment, an electro-magnet is provided instead of a permanent magnet which is powered by a separate battery in the rotary tool that is attached to the rotary element and can be activated by a switch. In yet further embodiments, an electro-magnet is provided that is powered by the rotary tool's primary power source. In additional embodiments a metallic ring or metal surface, other shaped magnet (or magnets) are oriented on the apparatus at a location where they are attracted to a ring-shaped magnet that is affixed, either permanently or temporarily, to the rotating portion of a rotary tool.

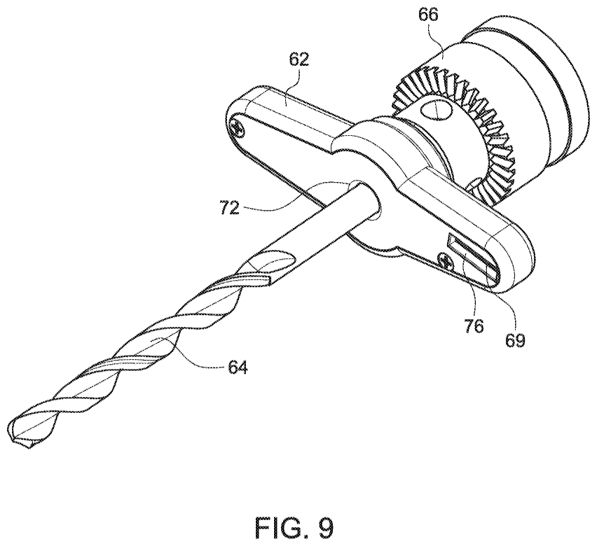

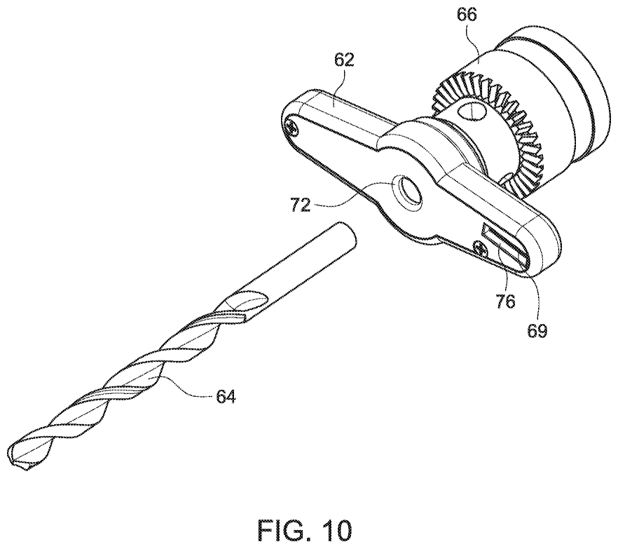

In the embodiment depicted in FIGS. 9 and 10 apparatus 62 contains fixed dimension slot or opening 72 for cutting tool 64 that keeps apparatus 62 automatically centered on cutting tool 64. In this embodiment the magnet is enclosed in apparatus 62. When rotating portion 66 of the rotary tool is rotating, apparatus 62, which is centered on cutting tool 64, rotates about the same rotational axis of rotating portion 66 of the rotary tool, which provides balance and stability. Further, fixed dimension slot or opening 72 can be slightly larger than the diameter of cutting tool 64, which allows apparatus 62 to safely and quickly disconnect from rotating portion 66 of the rotary tool if apparatus 62 is obstructed during rotation by an external object. FIG. 10 depicts a partially exploded view of apparatus 62 and cutting tool 64 where opening 72 for cutting tool 64 is visible. In this embodiment, apparatus 62 contains a laser and optics in optics assembly 69 that are used for worksurface alignment. The laser projection or projections emerge from one or more windows 76 in apparatus 62. In further embodiments, additional laser and optic combinations may be provided for depth detection, worksurface alignment or both.

In a further embodiment related to FIG. 9, apparatus 62 contains fixed dimension slot or opening 72 that centers on the drill chuck jaws instead of cutting tool 64.

In another embodiment related to FIG. 9, apparatus 62 contains a large slot or opening and an independent set of adjustable centering jaws such as a vice-type of grip that can be adjusted for a specific diameter cutting tool 64. When the adjustable centering jaws are tightened onto or around the cutting tool, apparatus 62 becomes centered with the cutting tool. In this embodiment the adjustable centering jaws can accept and auto-adjust to a wide variety of cutting tool diameters and are not limited to a single diameter cutting tool such as depicted in FIG. 9.

In another embodiment related to FIG. 9, the apparatus contains a large slot or opening and a set of spring steel entities that forces apparatus 62 to be centered on the cutting tool. In this embodiment the spring steel can accept and auto-adjust to a wide variety of cutting tool diameters and is not limited to a single diameter cutting tool such as depicted in FIG. 9.

In another embodiment related to FIG. 9, the apparatus contains a large slot or opening and a set of spring-loaded centering jaws such as a vice-type of grip that can auto-adjust for a specific diameter cutting tool. When the spring-loaded centering jaws auto-adjust onto the cutting tool, the apparatus becomes centered with the cutting tool. In this embodiment the spring-loaded centering jaws can accept and auto-adjust to a wide variety of cutting tool diameters and are not limited to a single diameter cutting tool such as FIG. 9.

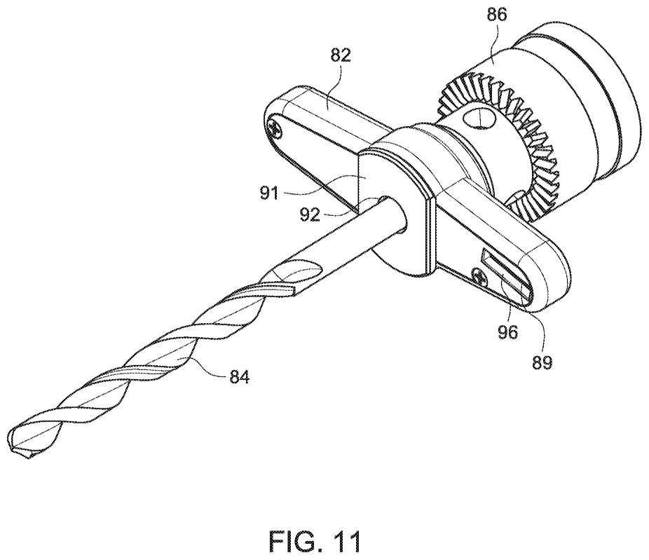

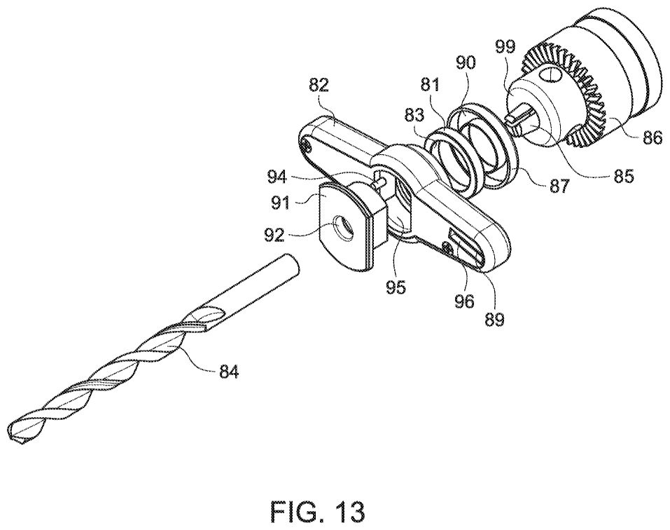

In the embodiment depicted in FIGS. 11-17, apparatus 82 contains fixed dimension opening 92 through member 91 for cutting tool 84 that forces apparatus 82 to be automatically centered on cutting tool 84. As seen in FIGS. 13, 14, and 15 of this embodiment, magnet 81 is enclosed in the apparatus in proximity to rear surface of apparatus 82 to allow it to form a magnetic coupling attachment with rotary tool 86. Unlike the embodiment in FIGS. 9 and 10 however, fixed dimension opening 92 is part of removeable part 91 that can be added or inserted into apparatus 82 as needed to conform to different sized cutting tools. For example, a kit or system may be provided that includes a series of removeable elements 91, each of which provides a specific fixed dimension opening 92 and corresponds to a particular diameter drill bit, e.g., ½″ round, ⅜″ round, ¼″ round, ¼″ hex shank. This allows single apparatus 82 to operate with drill bits of many sizes through use of several removable parts 91.

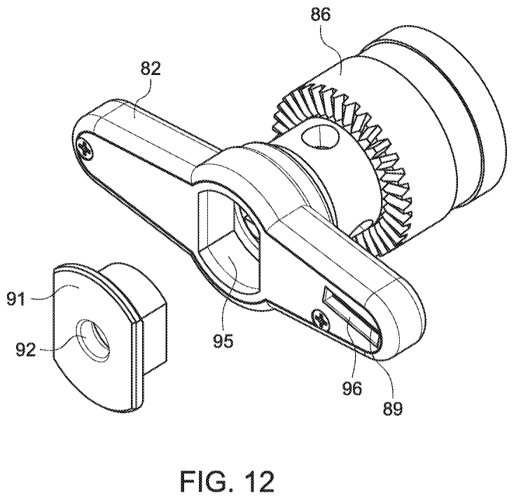

FIG. 11 is an isometric view of a rotary tool apparatus attachment and alignment system embodiment that is used to attach apparatus 82 to rotating portion 86 of the rotary tool. This embodiment also aligns apparatus 82 with cutting tool 84 using removable entity 91. When rotating portion 86 of the rotary tool is rotating, apparatus 82, which is centered on cutting tool 84, rotates about the same rotational axis of rotating portion 86 of the rotary tool, which provides balance and stability. Further, fixed dimension slot or opening 92 can be slightly larger than the diameter of cutting tool 84, which allows apparatus 82 to safely and quickly disconnect from rotating portion 86 of the rotary tool if apparatus 82 is obstructed during rotation by an external object. FIG. 12 depicts a partially exploded view of the embodiment from FIG. 11 with removable entity 91 depicted outside of apparatus 82. In this figure removable entity 91 and compartment or cavity 95 in apparatus 82 are visible. In this embodiment compartment or cavity 95 is a fixed size, shape and depth that allows for a series of removeable entities 91, each of which provides a specific fixed dimension opening 92 and corresponds to a particular diameter drill bit, to be inserted into the apparatus as required.

As seen in FIG. 13, magnet 81 is a ring-shaped element having inner diameter 83 that is large enough to insert and transit the largest possible cutting tool 84 that may fit within chuck jaws 85 of the rotating element 86. Magnet 81 may be neodymium iron boron, samarium cobalt, alnico, ceramic ferrite, as well as other types known in the art. In this embodiment the shape of apparatus 82 allows it to be virtually transparent while rotating which permits the user to see the surface that is being engaged by cutting tool 84. Inner diameter 83 of ring magnet 81 (and the opening of cap 87) is large enough to accommodate a variety of sized cutting tools that may be received in jaws 85 of chuck 86. Magnet 81 is used to attach apparatus 82 to rotating portion 86 of a rotary tool. In this embodiment, apparatus 82 contains a laser and optics in optics assembly 89 that are used for worksurface alignment. The laser projection or projections emerge from one or more windows 96 in apparatus 82. In further embodiments, additional laser and optic combinations may be provided for depth detection, worksurface alignment or both.

Now referring to FIGS. 13, 14, and 15, removable entity 91 contains one or more embedded elements 94 that are magnetically attractive. These elements include but are not limited to ferrous material or actual magnets. This configuration allows removable entity 91 to magnetically mount into compartment or cavity 95 based on the magnetically attractive force of ring magnet 81. In one embodiment, embedded element (or elements) 94 is/are a ferrous material that is/are attracted to magnets such as iron, steel, cobalt, nickel, or other magnetically attractive materials known in the art. In another embodiment, embedded element (or elements) 94 is/are small magnets that is/are oriented so that they are magnetically attracted to ring magnet 81.

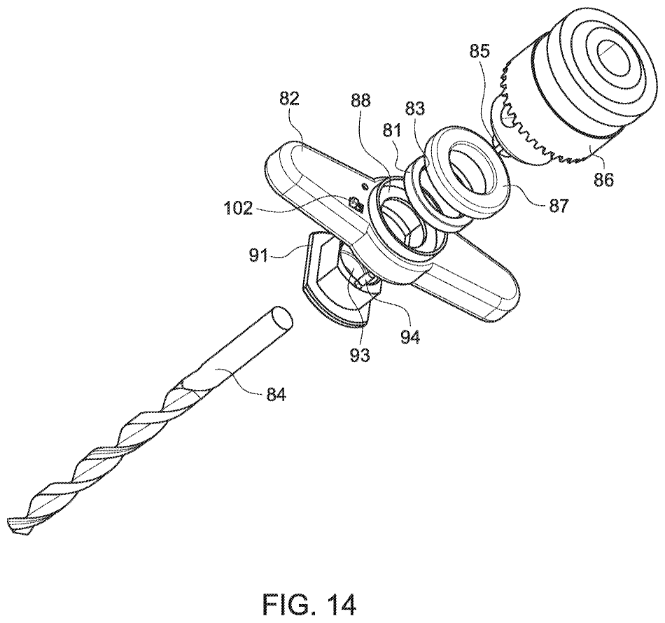

FIG. 14, which depicts an exploded view of the reverse side of apparatus 82 shows magnet 81 exposed, along with cap 87 which covers magnet 81 within apparatus 82. FIG. 14 also depicts annular cavity 88 within apparatus 82 that receives magnet 81, and power switch 102 that can turn the laser or lasers in apparatus 82 on or off.

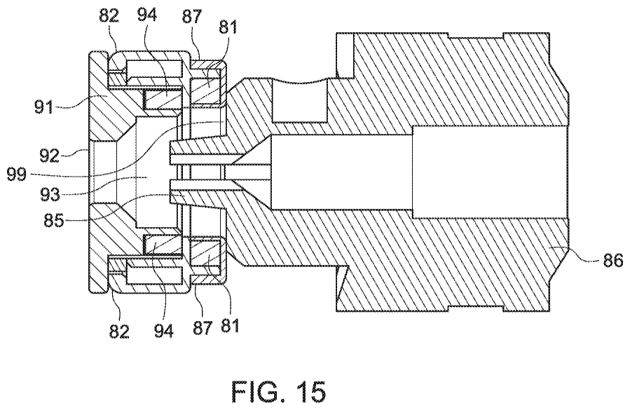

FIG. 15, a sectional view of the device of the embodiment depicted FIGS. 11-17, and shows the arrangement of apparatus 82 in engagement with rotational element 86 of a rotary tool. As shown here cap 87 is in contact with surface 99 of rotational element 86 of a rotary tool. Immediately behind cap 87 is magnet 81 which is connected by magnetic attraction to surface 99 of rotational element 86 of a rotary tool. Also depicted in FIG. 15 is cavity 93 in apparatus 82 that is large enough to accommodate both jaws 85 of the chuck 86 and a variety of sized cutting tools that may be received in jaws 85 of chuck 86. Hole 92 in the front of the apparatus is also large enough to accommodate a variety of sized cutting tools that may be received in jaws 85 of chuck 86.

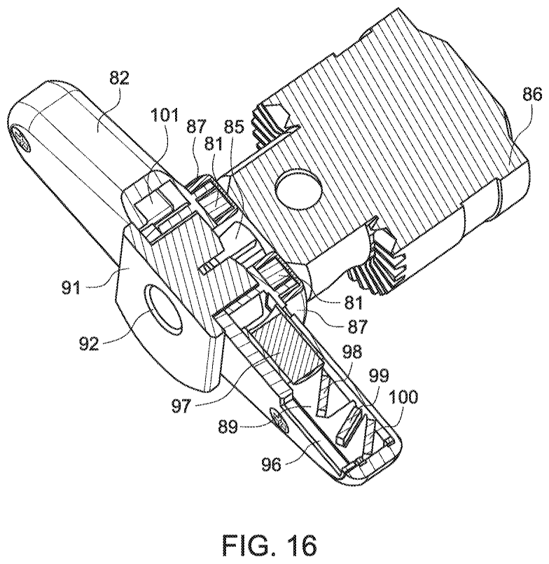

FIG. 16 depicts a partial sectional view of the embodiment from FIGS. 11, 12, 13, 14, 15, and 17, along the plane that encloses optics assembly 89 within apparatus 82 and rotating portion 86 of the rotary tool. In this embodiment optics assembly 89 contains laser 97, two beam splitters 98 and 99, and first side mirror 100 that projects beams (not pictured) through window 96, and operate in combination to provide worksurface alignment functionality. Battery 101 that powers the laser is also depicted. In further embodiments, additional laser and optic combinations may be provided for depth detection, or both depth detection and work surface alignment, as well as a separate light or set of lights that can be used to illuminate the worksurface. Further embodiments may also utilize several magnets arranged in a pattern versus single ring magnet 81, or utilize one or more electromagnets that are also powered by battery 101.

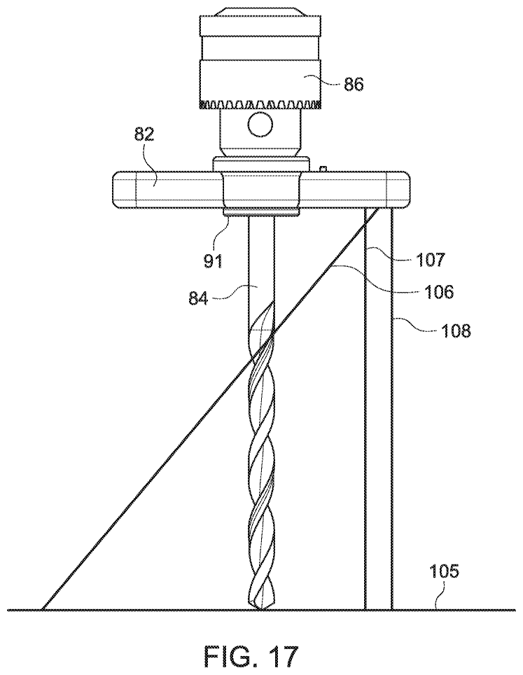

FIG. 17 is a side view of the embodiment in FIGS. 11, 12, 13, 14, 15, and 16. In this embodiment laser projections 106, 107, and 108 that originate in optics assembly 89 in apparatus 82 are visible. In this figure worksurface 105, cutting tool 84, and removable entity 91, and rotating portion 86 of the rotary tool are also depicted.

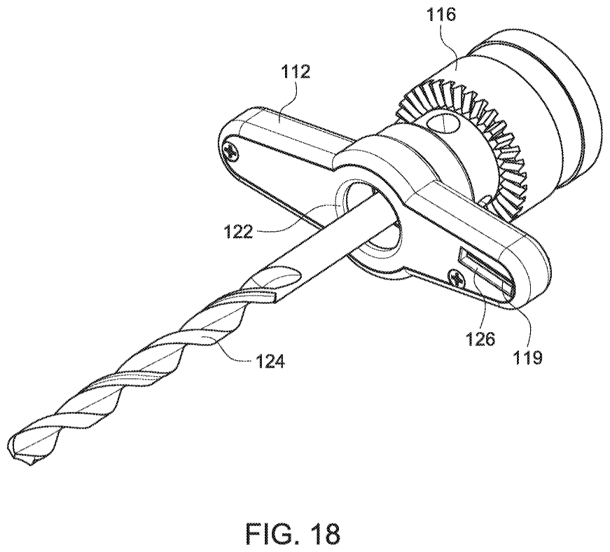

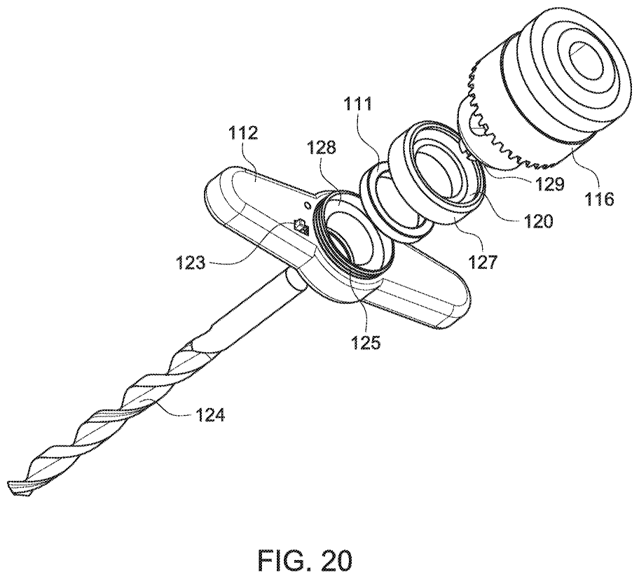

In the embodiment depicted in FIGS. 18, 19, 20, and 21, apparatus 112 contains removable cap 127 that aligns with some feature of rotating portion 116 of the rotary tool and forces apparatus 112 to be centered and automatically aligned on rotating portion 116 of the rotary tool and thus cutting tool 124. In this embodiment, the feature of rotating portion 116 of the rotary tool is face 130 and front chamfered edge 129. This embodiment presents an advantage over previous embodiments that automatically center on the cutting tool, because automatic centering with rotating portion 116 of the rotary tool allows the user to operate with any cutting tool diameter on the same rotary tool without the need for any built-in cutting tool guidance, such as hole 72 in FIG. 10, or removable element 91 with hole 92 in FIG. 12. In this embodiment, apparatus 112 contains a laser and optics in optics assembly 119 that are used for worksurface alignment. The laser projection or projections emerge from one or more windows 126 in apparatus 112. In further embodiments, additional laser and optic combinations may be provided for depth detection, worksurface alignment or both.

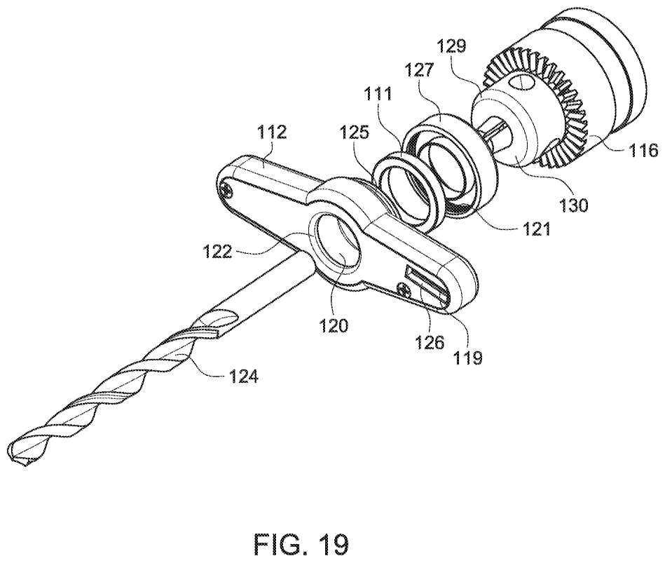

As shown in FIGS. 19, 20 and 21 rotary tool facing side 120 of removable cap 127 mirrors shape of the face 130 and front chamfered edge 129 of rotating portion 116 of the rotary tool (the drill chuck) and is in contact and centered with rotating portion 116 of a rotary tool. Immediately behind interchangeable cap 127 is magnet 111, which sits in annular cavity 128 of apparatus 112, and which is connected by magnetic attraction to face 130 of rotational element 116 of a rotary tool. In this embodiment removable cap 127 has threaded element 121 that screws onto threaded element 125 on apparatus 112. This allows for replacement of cap 127 due to wear and tear, or more importantly the ability to utilize same apparatus 112 with a diverse set of chuck-specific removable caps 127 that each individually fit onto and center-align with a unique brand and model of chuck.

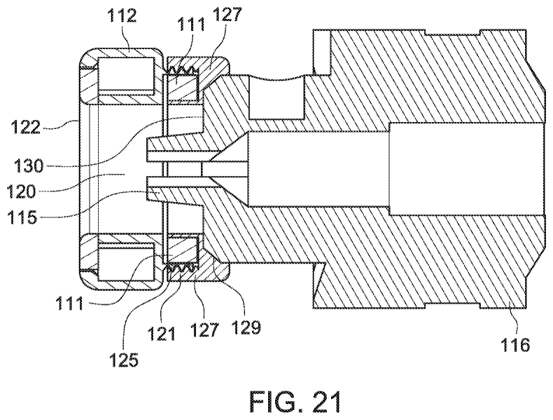

FIG. 21, a sectional view of the device of FIGS. 18, 19, and 20, shows the arrangement of apparatus 112 in engagement with rotational element 116 of a rotary tool. As shown here removable cap 127 is in contact with both face 130 and front chamfered edge 129 of rotational element 116 of a rotary tool. Immediately behind cap 127 is magnet 111 which is connected by magnetic attraction to face 130 of rotational element 116 of a rotary tool. Removable cap 127 has threaded element 121 that screws onto threaded element 125 on apparatus 112. Also depicted in FIG. 21 is cavity 120 in apparatus 112 that is large enough to accommodate both jaws 115 of the chuck 116 and a variety of sized cutting tools that may be received in jaws 115 of chuck 116. Hole 122 in the front of apparatus 112 is also large enough to accommodate a variety of sized cutting tools that may be received in jaws 115 of chuck 116.

In another related embodiment, cap 127 contains a small circular, semi-circular, or other shaped protrusion that aligns with chuck jaw hole in rotating portion 116 of the rotary tool.

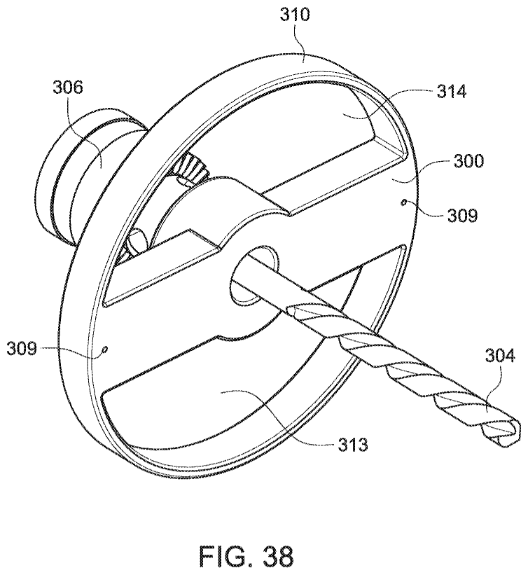

In an embodiment depicted in FIGS. 38, 39, and 40, apparatus 300 includes annular or ring-shaped section 310. The magnet is a single, permanent, ring-shaped magnet 301 that is affixed, either permanently or temporarily, within or to apparatus 300. In this embodiment, inner diameter 303 of ring magnet 301 is typically large enough to insert and transit the largest possible cutting tool 304 (such as a ½-inch drill bit if the rotary tool is a drill) for the operational intent. Inner diameter 303 of the ring magnet 301 (and the opening in cap 307) is also typically large enough for the cutting tool holder mechanism such as jaws 305 of chuck 306 to attach to cutting tool 304. Magnet 301 is used to attach apparatus 300 to surface 315 of rotating portion 306 of the rotary tool.

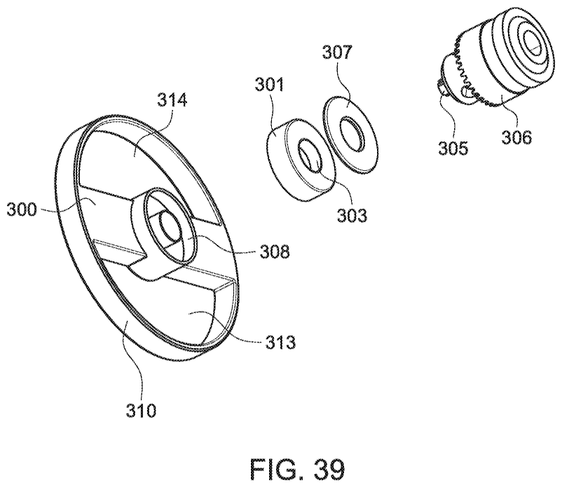

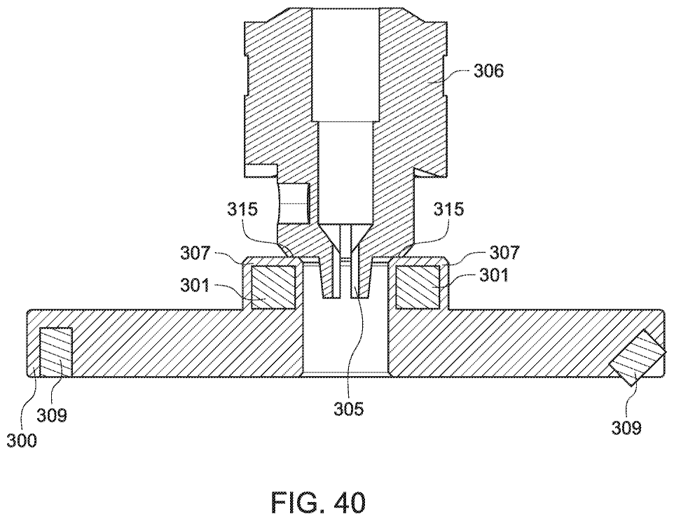

FIG. 39 depicts an exploded view of the reverse side of apparatus 300 with magnet 301 exposed along with cap 307 or portion of the apparatus housing that covers or encloses it within apparatus 300. FIG. 39 also depicts slot 308 within apparatus 300 that magnet 301 fits into. FIG. 40 depicts a sectional view of the embodiment from FIGS. 38 and 39. In this embodiment, apparatus 300 contains one or more lasers and optics 309 that are used for worksurface alignment. In further embodiments, additional laser and optic combinations may be provided for depth detection, worksurface alignment or both. An advantage of the embodiment in FIGS. 38-40 is annular or ring-shaped element 310 that provides an additional element of safety by preventing potential obstructions, such as an external object, from interfering with apparatus 300 during rotation. Annular or ring-shaped element 310 also contains open sections 313 and 314 that reduce the overall weight of apparatus 300. This same annular or ring-shaped element 310 can also be applied to other rotary embodiments here within.

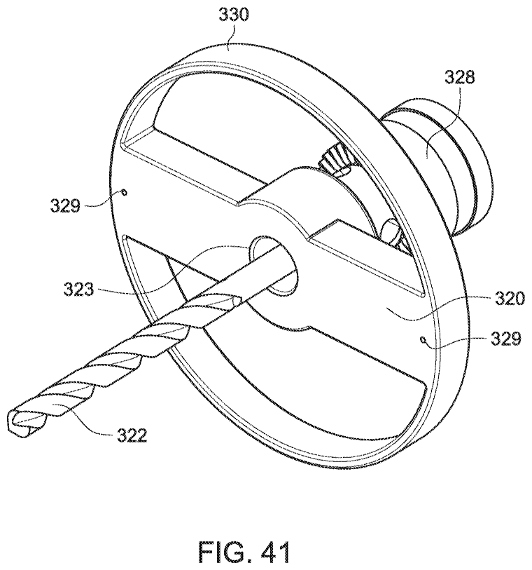

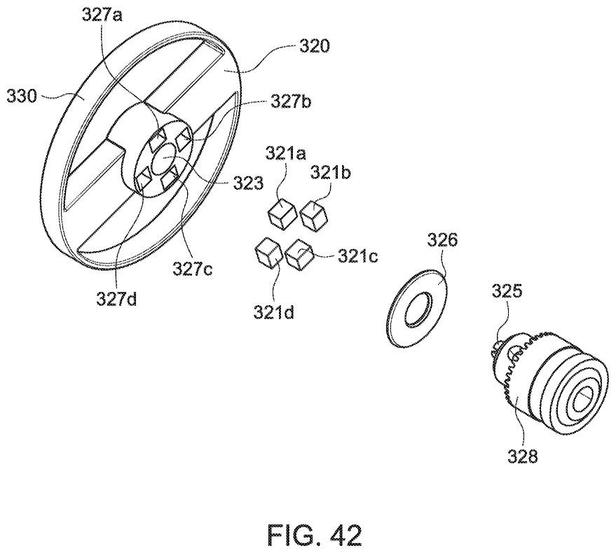

In another embodiment depicted in FIGS. 41 and 42, the magnets are a group of permanent, rectangular (or other) shaped magnets 321 that are arranged in a circular pattern (in this embodiment at the 0, 90, 180, and 270 degree positions) and are affixed, either permanently or temporarily, to apparatus 320. In this embodiment, central space between all four magnets 323 is typically large enough to insert and transit largest possible cutting tool 322 (such as a ½-inch drill bit if the rotary tool is a drill) for the operational intent. Inner diameter 323 (and opening in the cap 326) is also typically large enough for the cutting tool holder mechanism such as jaws 325 of chuck 328 to attach to cutting tool 322. Magnets 321 are used to attach apparatus 320 to rotating portion 328 of the rotary tool. FIG. 42 depicts an exploded view of the reverse side of apparatus 320 with magnets 321 exposed along with cap 326 or portion of the apparatus housing that covers or encloses them within apparatus 320. FIG. 42 also depicts slots 327 within apparatus 320 that magnets 321 fits into. In this embodiment, apparatus 320 contains one or more lasers and optics 329 that are used for worksurface alignment. In further embodiments, additional laser and optic combinations may be provided for depth detection, worksurface alignment or both.

In another embodiment similar to FIGS. 38-42, magnet 301 or magnets 321 are electromagnetic magnets instead of permanent magnets. In this embodiment, the electromagnetic magnet or magnets can also be turned on an off, and are powered by batteries inside or adjacent to the apparatus.

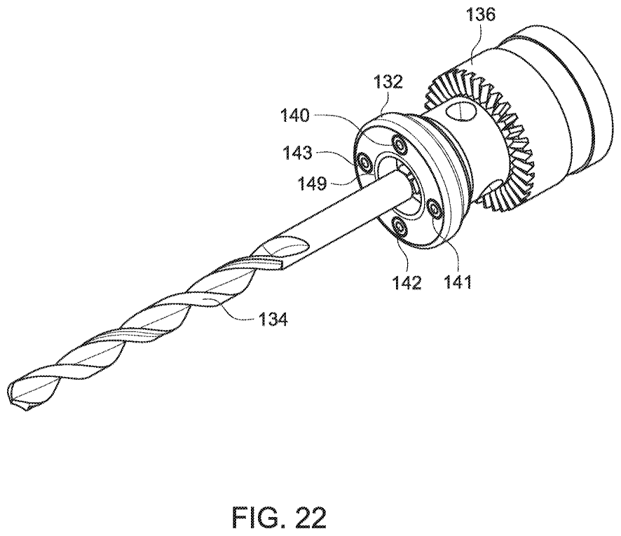

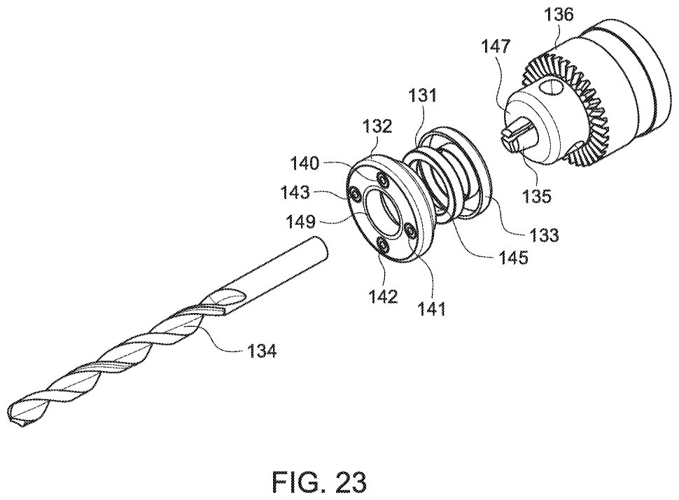

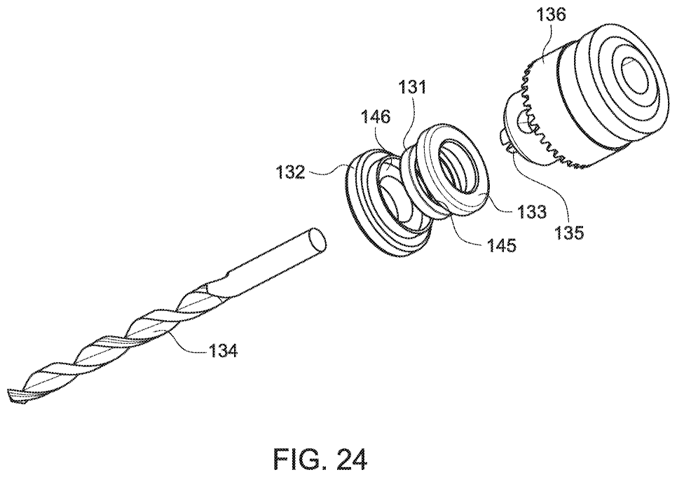

Now referring back to FIG. 22, apparatus 132 includes a work surface illumination system that has light sources 140, 141, 142, and 143 that, when attached to rotating portion 136 of the rotary tool are directed toward a worksurface to provide illumination. The light source 140 is received and retained in a cavity 159 on the top surface of arm 155. Cutting tool 134 passes though apparatus 132, and apparatus 132 is retained on rotating portion 136 of the rotary tool. As seen in exploded view FIG. 23, this embodiment contains a single, permanent, ring-shaped magnet 131 that fits into apparatus 132. Inner diameter 145 of ring magnet 131 and the opening in cap 133 is large enough to insert and transit the largest possible cutting tool 134, such as a drill bit, for the intended operation. Inner diameter 145 of ring magnet 131 and cap 133 are large enough for the cutting tool holder mechanism such as jaws 135 of chuck 136 to attach a variety of sizes of cutting tools. Magnet 131 is used to attach apparatus 132 to rotating portion 136 of the rotary tool. FIG. 24 depicts an exploded view of the reverse side of apparatus 132 with magnet 131 exposed along with cap 133 that covers or encloses it within apparatus 132. This figure also depicts annular cavity 146 that is provided within apparatus 132 to receive magnet 131.

In the embodiment light source or sources 140, 141, 142, and 143 are powered by a battery and the illumination may be triggered by a power switch. In another embodiment, a sensor is provided that detects rotation of apparatus 132 and, in response, triggers a switch to illuminate the light sources.

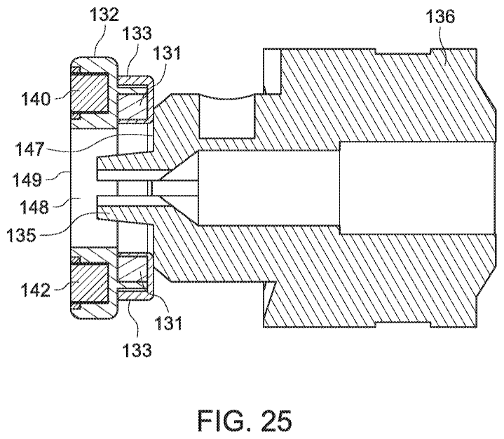

FIG. 25, a sectional view of the of the apparatus of FIGS. 22, 23, and 24, shows the arrangement of apparatus 132 in engagement with rotational element 136 of a rotary tool and two of four light sources 140 and 142. As shown here cap 133 is in contact with the surface 147 of rotational element 136 of a rotary tool. Immediately behind cap 133 is magnet 131 which is connected by magnetic attraction to surface 147 of the rotational element 136 of a rotary tool. Also depicted in FIG. 25 is cavity 148 in apparatus 132 that is large enough to accommodate both jaws 135 of chuck 136 and a variety of sized cutting tools that may be received in jaws 135 chuck 136. The hole 149 in the front of the apparatus is also large enough to accommodate a variety of sized cutting tools that may be received in jaws 135 of chuck 136.

The light sources in apparatus 132 may be anything known in the art, including but not limited to LEDs. Further, the quantity, position, arrangement, and other characteristics of the light sources such as color or brightness may vary.

Other embodiments of the apparatus in FIGS. 22 to 25 may also optionally include any of the methods or mechanisms defined for centering apparatus 132 on rotational element 136 of a rotary tool. This may include any of the centering methods or mechanisms, or related centering methods or mechanisms, outlined in the embodiments depicted in FIGS. 9 through 21, including but not limited to statically centering on the cutting tool, dynamically centering on the cutting tool, centering on the cutting tool through means of removeable entity 91 as in the embodiment in FIGS. 12-17, or centering on the rotational portion of the rotation element, such as in the embodiment in FIGS. 18-21 that has the ability to utilize the same apparatus with a set of chuck-specific removable caps 127 that each individually fit onto and center-align with a unique brand and model of chuck.

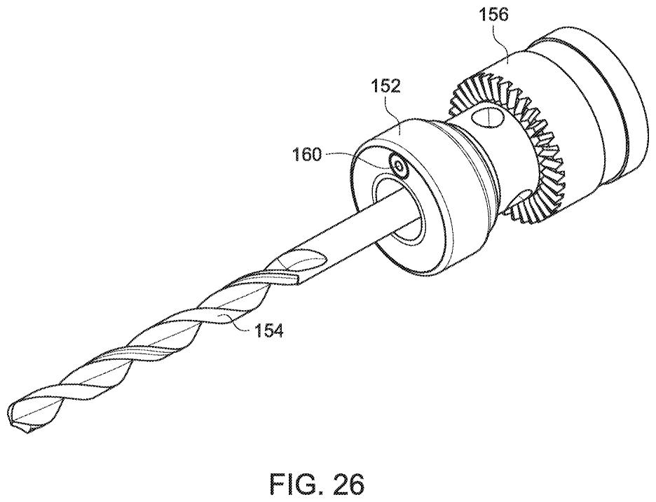

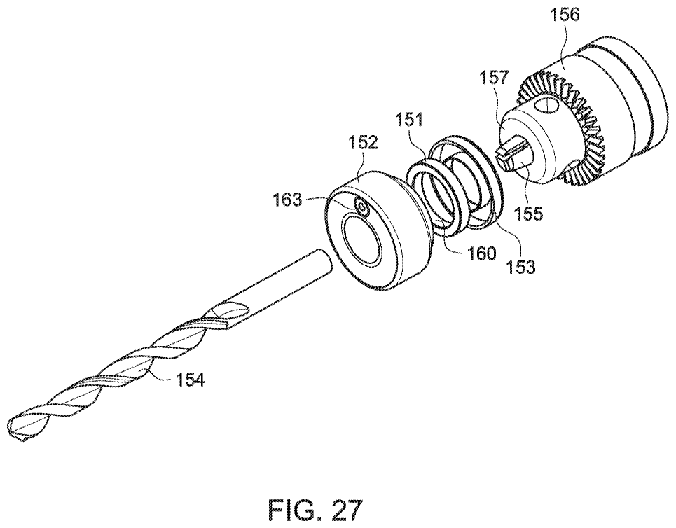

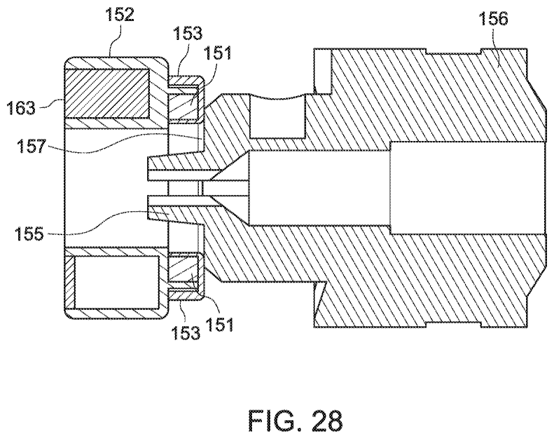

In an embodiment of the invention depicted in FIGS. 26, 27, and 28, apparatus 152 interacts with a separate device (not depicted) on the work surface (not depicted) by means of laser 160. When attached to rotating portion 156 of the rotary tool that contains cutting tool 154, apparatus 152, which contains laser 160, rotates with rotating portion 156 of the rotary tool. This motion creates a generally circular rotating projection onto a separate device (not depicted) that is provided on the work surface (not depicted). This rotating projection can be used by the separate device (not depicted) on the work surface (not depicted) to determine work surface alignment, drill bit depth or both. The magnet is a single, permanent, ring-shaped magnet 151 that is affixed, either permanently or temporarily, within or to apparatus 152. In this embodiment, inner diameter 160 of ring magnet 151 and the opening in cap 153 is typically large enough to insert and transit the largest possible cutting tool 154.

Inner diameter 160 of ring magnet 151 and cap 153 are large enough for the cutting tool holder mechanism, such as jaws 155 of chuck 156, to attach to cutting tool 154. Magnet 151 is used to attach apparatus 152 to surface 157 of rotating portion 156 of the rotary tool. Laser 163 is powered by an internal battery and its projected beam may be triggered by a power switch. In alternative embodiments, a laser is triggered by the rotation of the apparatus.

Other embodiments of the apparatus in FIGS. 26 to 28 may also optionally include any of the methods or mechanisms previously defined for centering the apparatus on the cutting tool or a rotational element of a rotary tool.

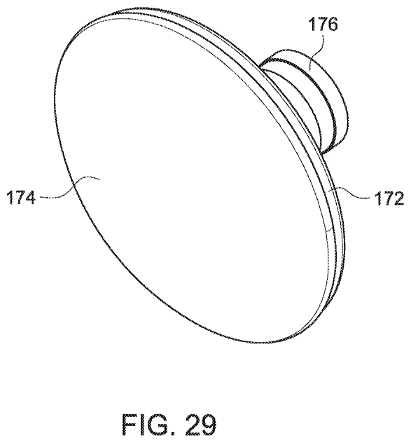

In the embodiment depicted in FIGS. 29, 30, 31, and 32, apparatus 172 is a holder that contains polishing pad 174. In this embodiment, apparatus 172 can also receive other types of elements such as sanding, abrasive, cleaning, grinding pads, or material application or removal pads.

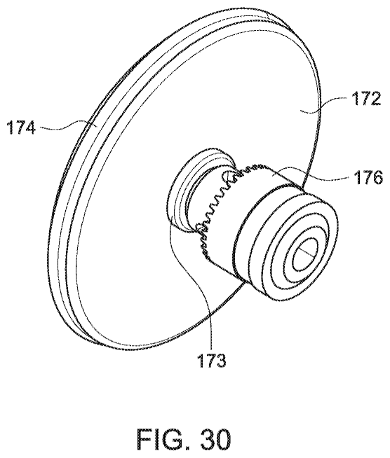

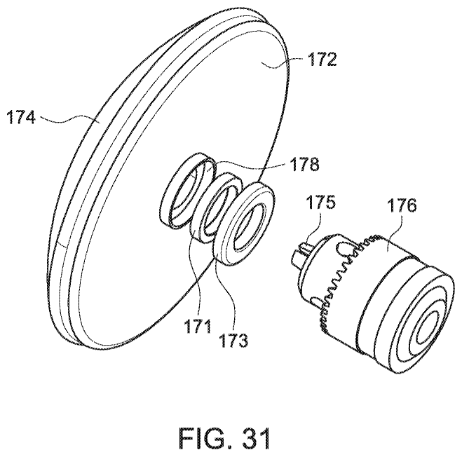

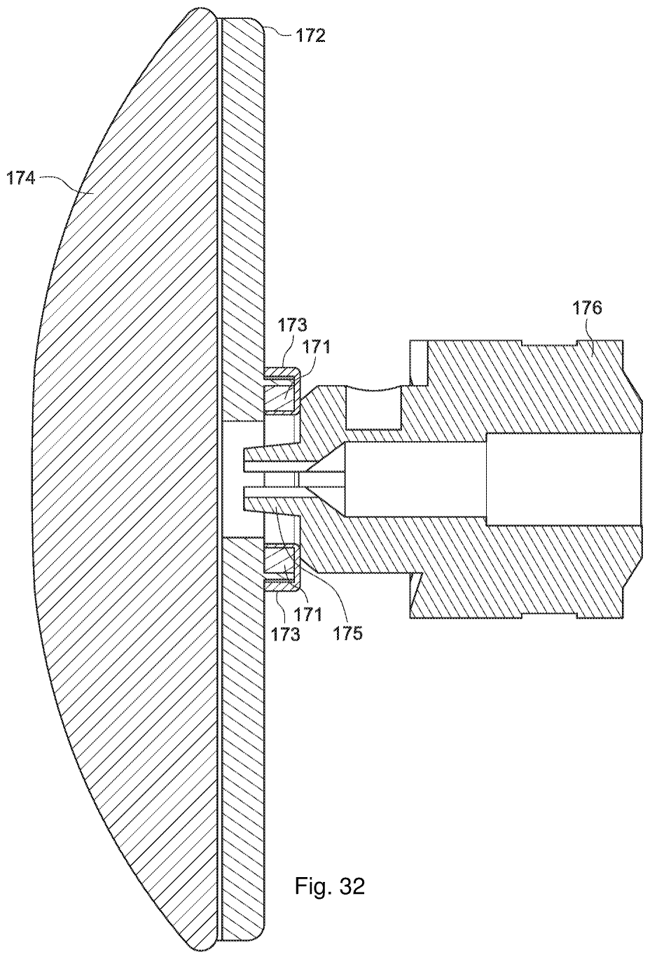

FIG. 29 depicts an isometric view of rotating portion 176 of the rotary tool, apparatus 172 (in this case a pad holder), and polishing pad 174. FIG. 30 depicts a reverse isometric view of the embodiment of FIG. 29. FIG. 31 depicts an exploded isometric view of rotating portion 176 of the rotary tool, polishing pad 174, apparatus 172 that receives pad 174, annular cavity 178 in apparatus 172 for magnet 171, and cap 173 that encloses the magnet in annular cavity 178 in apparatus 172. FIG. 32 contains a sectional view of polishing pad 174, apparatus 172 that receives pad 174, magnet 171, cap 173 that encloses magnet 171 in the apparatus 172, and rotating portion 176 of the rotary tool.

Other embodiments of the apparatus in FIGS. 29 to 32 may also optionally include any of the methods or mechanisms previously defined for centering the apparatus on the cutting tool or a rotational element of a rotary tool.

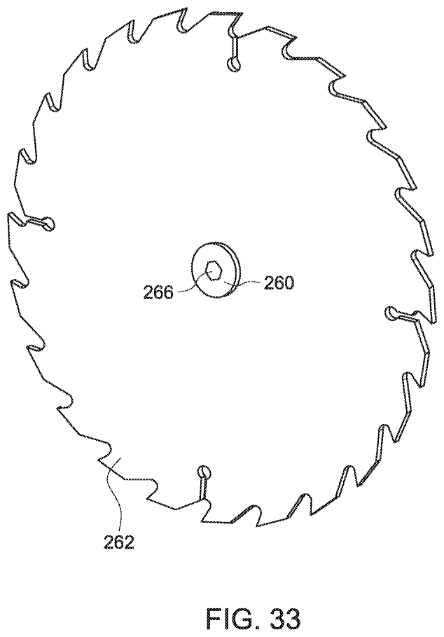

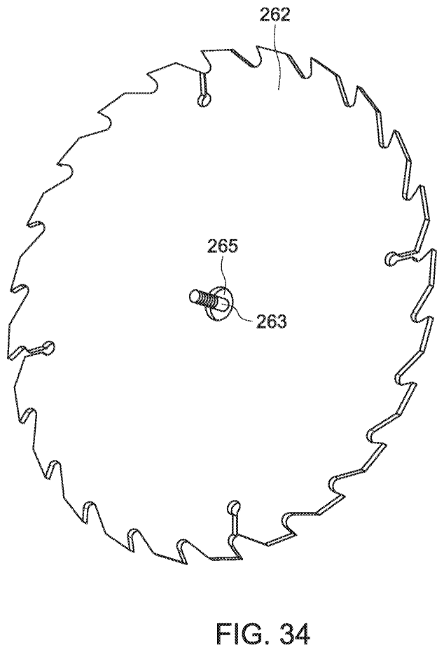

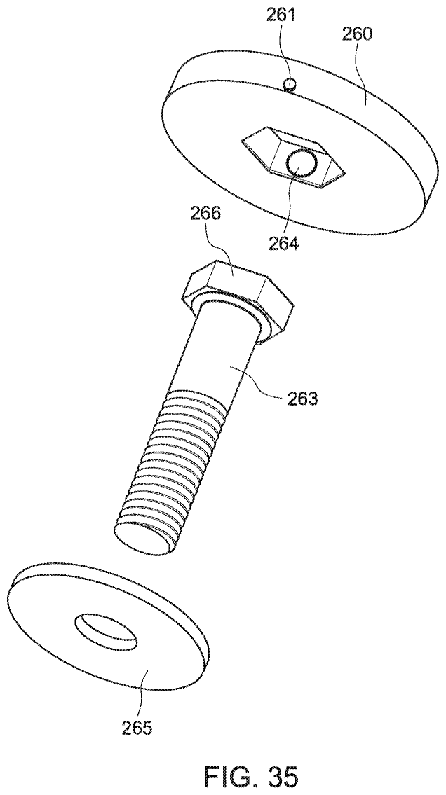

In the embodiment depicted in FIGS. 33, 34, and 35, the rotary tool is a rotary sawing type tool such as a circular or miter saw. In this example, apparatus 260 contains r 261 that is attached to a lateral surface of saw blade 262. As saw blade 262 rotates, laser 261 renders a linear path on the worksurface which serves as a guideline for saw blade 262. In this embodiment, apparatus 260 is magnetically attached to some portion of hex bolt 263 that secures saw blade 262 to the rotary saw. The apparatus contains one or more magnets 264 that magnetically attach to hex bolt 263. Since hex bolt 263 is at the center of rotation, hex bolt 263 serves as a means for alignment with the rotational axis of the rotary saw. Various rotary saws also include washer 265 or spacer between saw blade 262 and head 266 of hex bolt 263. Apparatus 260 may optionally cover entire head 266 of hex bolt 263 or some portion of it.

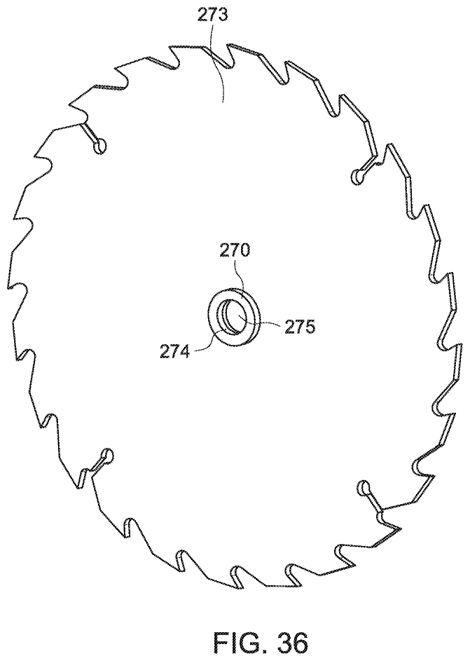

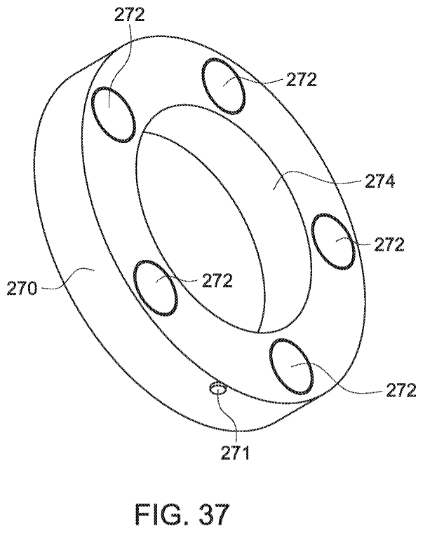

The embodiment depicted in FIGS. 36 and 37, apparatus 270 contains laser 271 and magnet 272. In embodiments a plurality of magnets 272 may be used to attach apparatus 270 to saw blade 273. As can be discerned by one having ordinary skill in the art, in this embodiment, apparatus 270 can be magnetically attached around the central portion of saw blade 273 which resides on a rotary saw such as a circular or miter saw. As the rotational portion of the saw and saw blade 273 rotates, laser 271 renders a linear path on the worksurface, which serves as a guideline for saw blade 273. Inner diameter 274 of apparatus 270 is circular and can thus be aligned around central portion 275 of the saw blade in a concentric manner.

While several magnetic “rotating portion of the rotary tool to apparatus” embodiments are detailed in this specification, a person having ordinary skill in the art will understand that there are additional combinations of magnet types and configurations that can be used to attach the rotating portion of a rotary tool to an apparatus. Further, a person having ordinary skill in the art will understand that there are additional types of rotary tools and apparatuses that can be magnetically attached to each other in the manner disclosed.

### Alignment of the Apparatus With the Rotating Portion of the Rotary Tool

The rotary tool apparatus attachment and alignment system also optionally includes a device for aligning the apparatus with the rotating portion of a rotary tool so that both are aligned during rotation, such as a spacer. Apparatus alignment allows the entire system to operate more efficiently along a single rotational axis. This provides greater stability, balance, and precision during system rotation.

### Apparatus Embodiments

The apparatus that is attached to the rotary element can be anything that enhances, improves, augments, or facilitates the rotary tool including but not limited to a worksurface alignment system, a drilling depth system, a worksurface light, a worksurface guidance or control system, debris removal system, or a cutting, sanding, cleaning, polishing, or material application or removal system. The apparatus is magnetically attached to some portion of the rotating portion of the rotary tool so that when the rotating portion of the rotary tool rotates, the apparatus also rotates. The term apparatus can refer to a simple entity such as a cutting tool or drill bit, or a more complex entity that results in one or more features such as a visual work surface alignment system or a drill bit depth system. If the apparatus is electronic, it may be triggered by a power switch, by the rotation of the apparatus, or by some combination thereof. Features discussed in each individual embodiment can be used singularly in an embodiment or in combination with each other. Through the embodiments depicted in FIGS. 1 to 21 and FIGS. 38 to 42 primarily demonstrate an implementation of a worksurface alignment system, other embodiments of each apparatus may serve different functions. In one embodiment the apparatus may be an alternative work surface alignment system that includes some means to indicate or transmit work surface alignment to a person or an external device. In another embodiment the apparatus may be a work surface drilling depth system that includes some means to indicate or transmit work surface drilling depth to a person or an external device. In another embodiment the apparatus may contain a subsurface object detection or identification system that includes some means to indicate or transmit subsurface object detection to a person or an external device. In yet another embodiment the apparatus may be some combination of a work surface alignment system, a work surface drilling depth system, or subsurface object detection system that includes some means to indicate or transmit work surface alignment, work surface drilling depth, or subsurface object detection to a person or an external device.

In the embodiment depicted in FIGS. 22 to 25, the apparatus is a work surface illumination system that includes one or more light sources that, when attached to the rotating portion of the rotary tool, are directed on or about a worksurface to provide illumination.

In the embodiment depicted in FIGS. 26 to 28, the apparatus is a work surface alignment system that interacts with a separate device on the work surface, a work surface drilling depth system that interacts with a separate device on the work surface, or some combination of both a work surface alignment system and a work surface drilling depth system that interacts with a separate device on the work surface. In all cases, the apparatus or separate device on the work surface includes some means to indicate or transmit work surface alignment and or work surface drilling depth to a person or an external device.

In the embodiment depicted in FIGS. 29, 30, 31, and 32, the apparatus contains polishing pad 174 in holder 172 that can also be used to receive other types of elements or wheels for differing purposes such as for cutting, sanding, abrasion, cleaning, grinding, or material application or removal.

In the embodiment depicted in FIGS. 33 to 37, the apparatus is a work surface cutting guideline for a rotary saw blade that includes some means to indicate or transmit a work surface cutting guideline to a person or an external device.

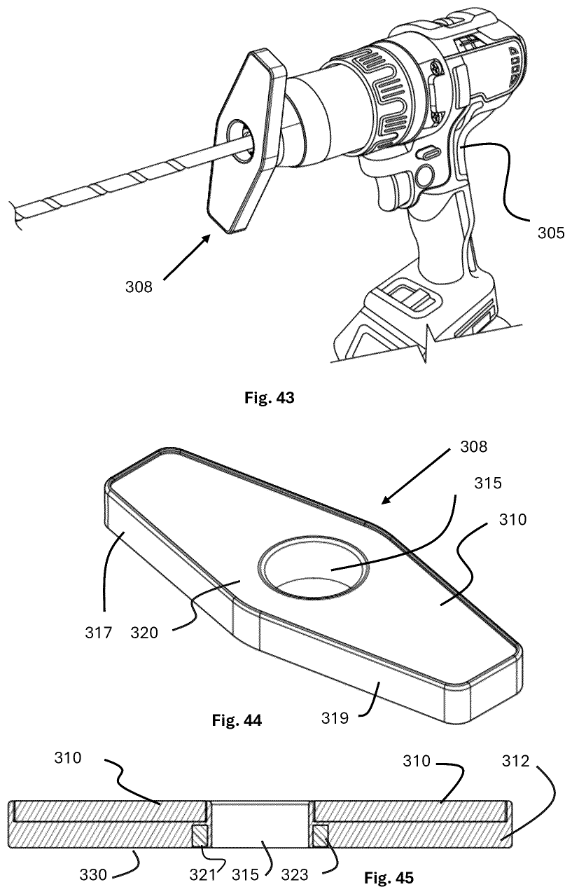

A further embodiment of the invention is depicted in FIGS. 43, 50, 60-62 wherein the tool that is held by the device is one or more mirrors or reflective elements and the mirror or reflective elements are oriented to face away from the rotary tool to which it may be attached. As such, in embodiments the secondary tool that is provided on the respective tool holder that attached to the chuck is a mirror or reflective surfaces. The assembly that includes a reflective surface and tool holder are referred to as the “reflector devices.” According to a further embodiment, the reflector devices work in conjunction with a worksurface alignment component that is designed to be positioned on the worksurface at or near a desired drilling location. The worksurface alignment component includes a visible laser that emits a beam, and when oriented on a worksurface, the beam is directed perpendicularly from the worksurface. When used in conjunction with the reflector device, the beam impinges on the reflective surface and is directed back toward the alignment components on the worksurface and these devices may be used to align the drill.

Referring now to FIG. 43, rotary tool 305 is depicted with a tool holder 308 that includes mirrored front surface 310. As best seen in FIG. 44, extending from a center core region 320 are arms 317 and 319. Tool holder 308 is provided with magnets positioned around central opening 315 on or near the rear surface of tool 330 holder 308. FIG. 45, a sectional view of tool holder 308 depicts magnets 321 and 323 next to central opening 315 and which are flush with the bottom surface 330. A mirror 310 is inlayed within the solid core 312 of tool holder 308. In this embodiment, when the rotary tool is powered on and running at high speed, the user is able to see the location where the cutting bit engaged the work surface. When combined with a worksurface alignment component, the alignment components may project a laser light perpendicular to the work surface, and the arms of the reflector device, which have mirrored front surfaces, will reflect back the laser beam to a top surface of the worksurface alignment component.

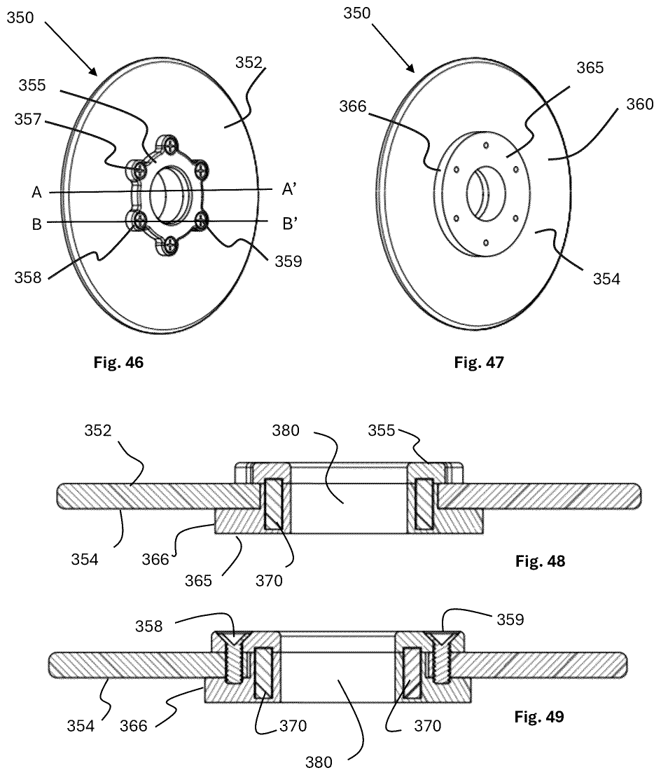

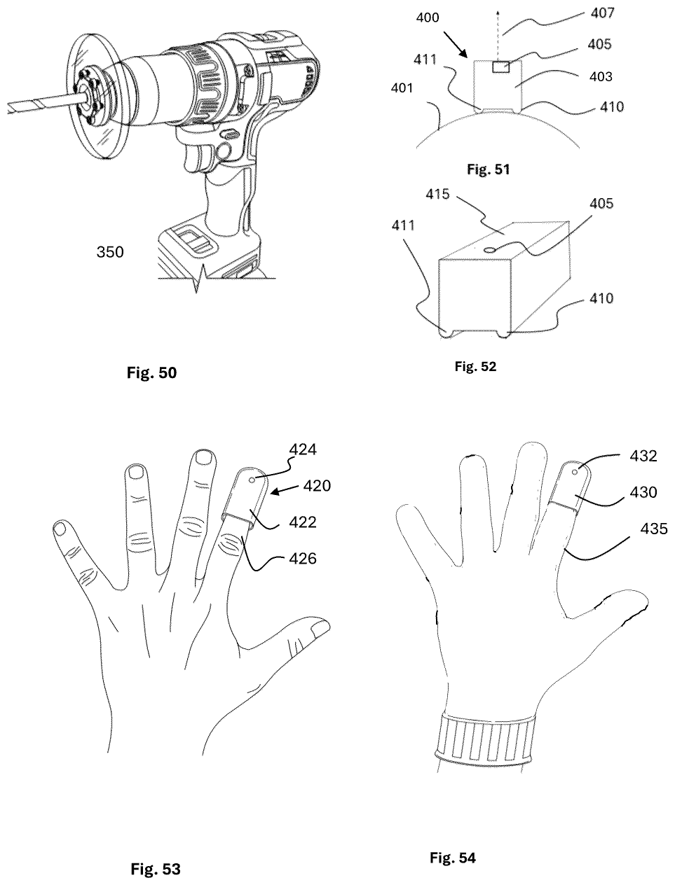

A further embodiment of a tool holder 350 that may be used with a worksurface alignment component is disk 350 as depicted in FIGS. 46 and 47. The front surface of disk is reflective or a mirror 350. In embodiments, disk 350 is made from transparent resin materials such as polymethyl methacrylate (PMMA) (acrylic), polycarbonate (PC), polyethylene terephthalate (PET), polyethylene terephthalate glycol (PETG), and polyvinyl chloride (PVC). Reflective coating material is applied to the rear surface 354 disk 350 so that light that impinges on the front of the disk 352 will be reflected. In embodiments, after the disk is coated with a reflective coating it remains transparent and objects on the other side are visible. In other embodiments the reflective regions of the disk are opaque but the user can see through the disk when it is spinning because a transparent regions are rapidly rotated into the user's line of sight. As best seen in FIGS. 48 and 49 disk 350 includes a ring magnet 370 that is positioned around central circular opening 380. Magnet 370 is retained in cavities provided in the core section 366 which extends in a perpendicular direction from the lower surface 354 of disk 350, thereby providing for a space between the end of the chuck and rear surface 354 of disk 350. The magnet is maintained in place by cap 355 which is secured by fasteners 357, 358 and 359 that extend through the flat portion of the disk. In alternative embodiments, the disk is provided with series of magnets that are received in a series of cavities in the core around a central opening. FIG. 50 depicts disk 350 attached to a rotary tool 450.

Now referring to FIG. 51, a side view of embodiment of a worksurface alignment component 400 is depicted on a curved worksurface 401. Worksurface alignment component 400 has legs 411 ad 410 that allow the component to remain stable. The worksurface alignment component 400 includes a laser 405 that projects a beam 407 perpendicular to the top surface 415.

FIG. 53 depicts a further embodiment of a worksurface alignment component 420 that can be inserted over a worker's finger 426 which allows the component to be positioned in a convenient place adjacent to location of the intended borehole. Surface 422 is designed to capture a reflected beam from a mirrored or reflective surface that is attached to the rotary tool. In operation, a worker aligns the rotary tool so that a reflected beam impinges on surface 422 at the location the laser beam originates to reflect that the cutting bit is in perpendicular alignment.

FIG. 54 operates in a similar fashion but the worksurface alignment component 430 having laser 432 is integrated into a glove 435 which can protect the workers hand, allows the component to be used in cold environments, and prevents direct contact of the worker hand with the worksurface.

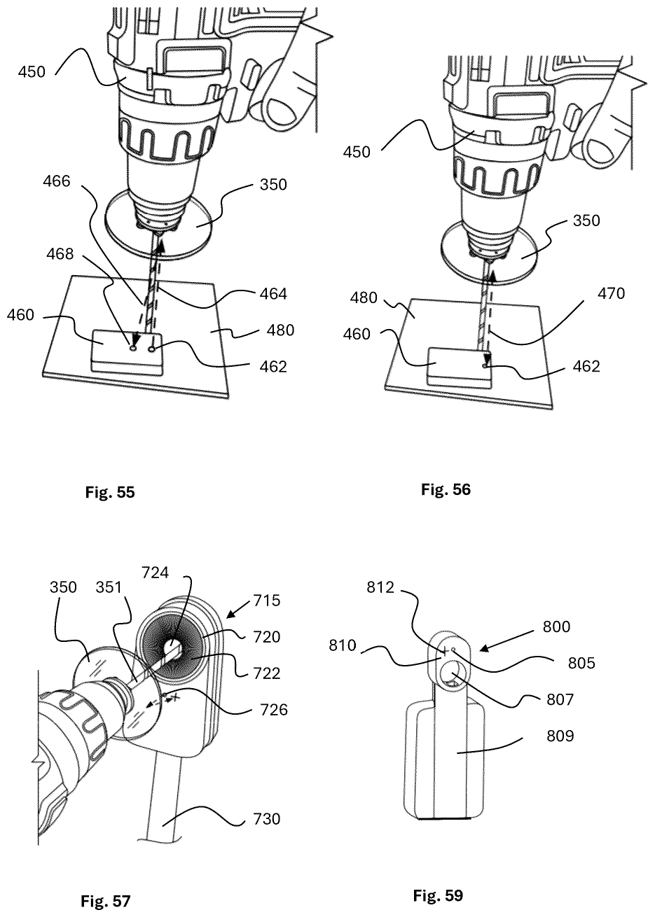

In operation, a user attaches a reflective device such as disk 350 to rotary tool 450 and positions worksurface alignment component 460 on a worksurface 480. As seen in FIG. 55, the alignment of the drill is not perpendicular and, consequently, light beam 463, which originates from laser 462 impinges on disk 350 and beam 466 is reflected back to worksurface alignment component where is impinges at surface location 468. In the illustration of FIG. 55, the disk and alignment component are not parallel with one another. The user can then adjust the orientation of the rotary tool 450 to a perpendicular position and, when the orientation reaches 90 degrees, referring to FIG. 56, beam 470 which originates from laser 462, reflects off disk 350 and back to the worksurface alignment component 460 to the location of laser 462 from which the beam emerges.

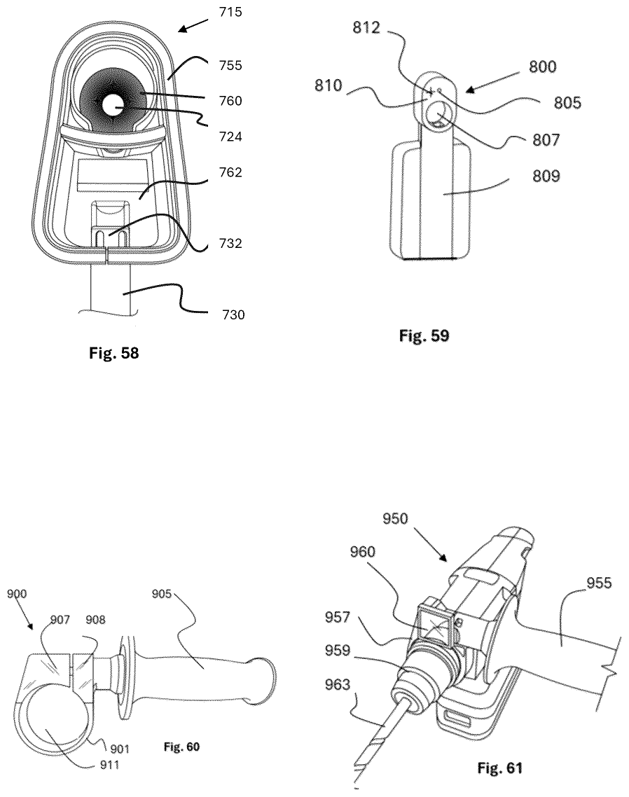

FIGS. 57 and 58 depicts yet a further embodiment of the worksurface alignment component 715 which includes a series of brushes 722 that extend in a radial direction from the cylindrical wall opening 720 toward a central axis through central opening 724. The brushes keep debris from spreading on the work surface and direct such material tubular passage 730 that is attached to a vacuum (not shown) which removes the debris. As seen in FIG. 58, an elastomeric material 755 is provided around the circumference of the read side of component 715 which assists in making an airtight or substantially airtight seal by application of pressure to the opposite side of the component. The tubular passage enters space 652 which may capture the larger piece of debris dislodged during the drilling operation and can be emptied when the drilling operation is complete. Smaller drilling debris exits space 732 though tubular passage 730.

FIG. 59 depicts a further embodiment of a worksurface alignment component 800 that is adapted to be attached to a vertical worksurface such as wall. The component includes an opening 807 through which a drill bit may be received. The component includes a laser 805 that projects a narrow beam perpendicular to surface 810. Surface 810 has an area 812 which can receive a reflected laser beam which is perceived as a dot on the area. Body 809 allows for the manipulation of the component and provides a location for a power source for laser 805.

Further embodiments of reflector devices that can be used in connection with worksurface alignment components to align the position of a rotary tool are depicted in FIGS. 60 and 61. These embodiments are designed to attach to stationary body part of a rotary tool and, since they are not attached to the chuck, will not rotate when power is activated. Reflector device 900 includes adjustable ring section 901, which can receive a chuck through opening 911. The ring section 901 can be adjusted to engage and attach to a nose portion of a drill that surrounds a chuck. A handle 905 that extends lateral to the drill is used to stabilize the drill and prevents the rotary drill body from rotating with the bit when the bit has engaged with a surface. Reflective mirrors 907 and 908 are provided that are oriented perpendicular to the axis of the drilling bit. Another embodiment of a reflector device that uses a stationary mirror affixed to the rotary drill is depicted at FIG. 61. This embodiment is shown attached to the body of a rotary tool behind the rotating parts including the chuck 959 and bit 962.

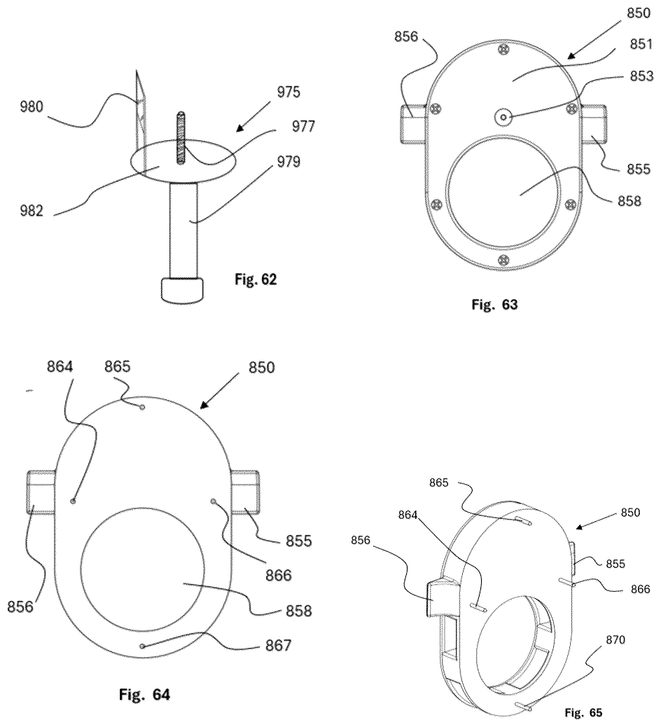

In a further embodiment, reflector part 975 shown in FIG. 62 includes a threaded rod that may be received in an opposite threaded cavity provided on the side of a rotary tool, a flange element 98 a handle 979 and spectral reflective surface 980.

Now referring to FIGS. 64-66, a further embodiment of a worksurface alignment component 850 is shown and includes a laser light source 853, a surface 851 on which a light beam may be reflected and detected by a user.

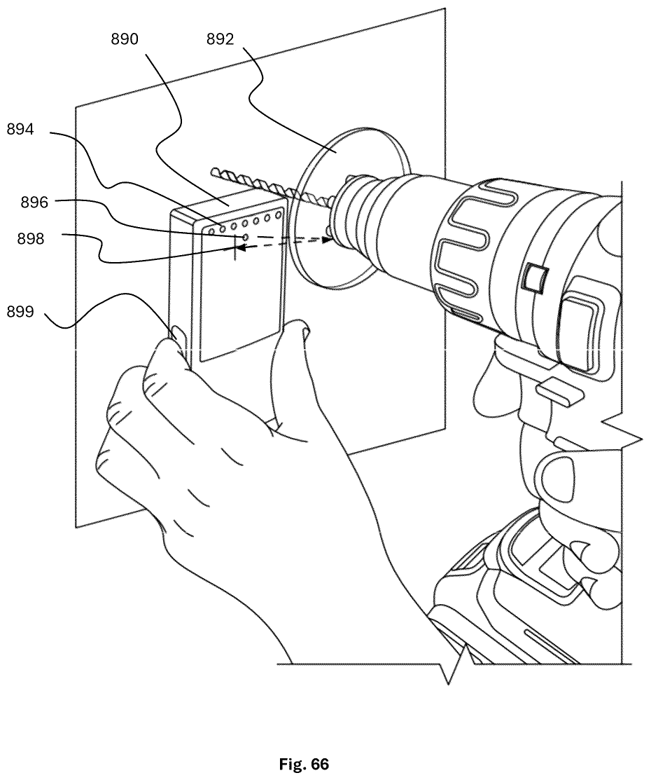

A through hole 858 allows a drill bit to pass through the work surface alignment component 850 and engage a surface. As best seen in FIG. 66, a series of pins 864,865, 866 and 867 extend from the bottom surface of component 850 which may be used to affix the device to a work surface. Opposite handles 855 and 856 are provided on the lateral sides which facilitate the attachment and removal of the device from the work surface.

FIG. 67 is yet a further embodiment of a worksurface alignment component 890 that is shown working in conjunction with reflector device 892. This embodiment includes a wall stud detection feature that senses the location of steel or wood upright members behind drywall, or other wall coverings. An array of LEDs 894 is illuminated when the device detects an underlying structure. Like the other worksurface alignment components, the device includes a laser source 896 that projects a light beam perpendicular to a flat surface area 898 that allows the user to detect the location of the reflected beam.

These various embodiments collectively demonstrate the versatility and adaptability of both the worksurface alignment components and the associated reflector devices. By allowing for adjustments in orientation, attachment methods, and even environmental accommodations—such as debris removal and operation on curved or vertical surfaces—the system ensures precise alignment for a variety of drilling scenarios. Whether the reflective components are integrated into rotating disk tool holders with magnets for attachment to a drill, or stationary mounts, and the work surface alignment component may take the form of various embodiments, the fundamental principle remains providing clear, real-time feedback to the user for accurate, perpendicular engagement of the rotary tool with a work surface.

While several apparatus embodiments are detailed in this specification, a person having ordinary skill in the art will understand that there are additional configurations of work surface alignment components that project a light beam and have a region to detect a reflected beam. These worksurface alignment components can work in conjunction with a variety of reflector devices that are attached to a drill and will reflect a light beam and can be used to align a drill.

1. A drilling alignment system comprising a worksurface alignment component and a reflector part, wherein
said worksurface alignment component comprises a body having a front surface that has a planar region and said has a light source that that projects a beam transverse to said planar region, and
said reflector part comprises a flat specular reflective surface and includes attachment elements to allow for attachment to a rotary tool and to orient said reflective surface away from said tool and perpendicular to an axis of rotation of said rotary tool.

2. The alignment system of claim 1 wherein said specular reflective surface comprises a beam splitter.

3. The alignment system of claim 1 wherein said specular reflective surface comprises a mirror.

4. The alignment system of claim 1 wherein said reflector is a disk having a central opening and said opening can receive a cutting bit and said attachment elements comprise at least one magnet.

5. The alignment system of claims 1 wherein at least a portion of said disk is transparent.

6. The alignment system of claim 4 wherein said magnets are provided on or below the rear side of said disk and the polarity of at least one magnet is parallel with said axis of rotation.

7. The worksurface alignment system of claim 1 wherein said reflector part further comprises a rear surface, a front surface and opposite arms that extend from a core region and said core region comprises a central opening and said opening can receive a cutting bit.

8. The worksurface alignment system of claim 7 wherein said specular reflective surface comprises a mirror attached to said front surface.

9. The alignment system of claim 7 wherein said attachment elements comprises at least one magnet at or near said rear surface.

10. The worksurface alignment system of claim 1 wherein said attachment elements comprise an adjustable ring that has a circumference that may be reduced and increased to allow the said reflector part to be attached to a circular exterior surface of said rotary tool when the circumference of said ring is reduced and be removed from said circular exterior surface of said rotary tool when the circumference of said ring is increased.

11. The worksurface alignment system of claim 10 further comprising a handle and said handle extends in a direction transverse to said axis of rotation of said rotary tool.

12. The worksurface alignment system of claim 1 wherein said attachment elements comprise a threaded rod and said rotary tool comprises a complementary threaded cavity.

13. A worksurface alignment component comprising a top first planar surface and a laser, said laser oriented to project a beam at a location on said surface and said beam is perpendicular to said surface and said planar surface has a region around said beam location that may receive a reflected laser beam and allow for detection by visible inspection.

14. The worksurface alignment components of claim 13 further comprising a slot sized to receive the tip of an index finger of a user.

15. The worksurface alignment component of claim 13 further comprising a central opening, and said opening is sized to receive a cutting bit.

16. The worksurface alignment component of claim 13 further comprising attachment elements extending from the rear surface of said device for temporary attachment to a worksurface.

17. The worksurface alignment component of claim 13 wherein said body comprises a magnet.

18. The worksurface alignment component device of claim 13 further comprising a second opening, said second opening comprising an end of a tubular body on which the opposite end of said tubular body is connected to a vacuum whereby debris on a worksurface and that dislodged from drilling is removed by said vacuum.
